(19) United States
(12) Patent Application Publication
(10) Pub. No.: US 2026/0040345 A1
(43) Pub. Date: Feb. 5, 2026

(54) METHODS AND APPARATUS FOR DYNAMIC LOAD BALANCING DURING RANDOM ACCESS IN AMBIENT INTERNET OF THINGS (AIOT) SYSTEMS

(71) Applicant: InterDigital Patent Holdings, Inc., Wilmington, DE (US)

(72) Inventors: Remun Koirala, London (GB); Erdem Bala, East Meadow, NY (US); Paul Marinier, Brossard (CA); Moon IL Lee, Melville, NY (US); Martino Freda, Laval (CA); Brian Martin, Farnham (GB); Ahmed Mostafa, Ottawa (CA); Jongwoo Hong, New York, NY (US); Aata El Hamss, Laval (CA)

(73) Assignee: InterDigital Patent Holdings, Inc., Wilmington, DE (US)

(21) Appl. No.: 18/794,797

(22) Filed: Aug. 5, 2024

(51) Int. Cl. H04W 74/00; H04W 72/044; H04W 84/18

(52) U.S. Cl. CPC H04W 74/002; H04W 72/044; H04W 84/18

(57) ABSTRACT

A wireless transmit and receive unit (WTRU) may receive, from a network, first configuration information including a first resource identification (ID) and an indication of time and frequency resources to be used in ambient Internet of things (AIoT) access procedure. The WTRU may also receive first assistance information associated with the first resource ID. The WTRU may determine, based on the first configuration and first assistance information, first resource to be used to send a first AIoT message. The WTRU may send the first message and monitor the access occasions to determine if an overload occasion occurred. Upon overload detection, the WTRU may send, to the network, an overload indication. The WTRU may receive, from the network, second assistance information. The WTRU may determine, based on the first configuration and first and second assistance information, a second resource to be used to send a second AIoT message.

### BACKGROUND

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may present peak power consumption of orders higher than 10 mW, adding a challenge when utilizing cellular devices for IoT applications that may require extremely low power consumption.

### SUMMARY

In an AIoT (AIoT) system, an AIoT device, such as a tag, communicates with a reader. The reader may be a UE. The tag may optionally communicate with an intermediate node, which may be a UE. The intermediate node may communicate with the base station, processing and/or relaying information associated with one or more AIoT devices. The reader or the intermediate node may have the capability of communicating directly with the AIoT device, over the AIoT interface, e.g., using RFID. The intermediate node may process and then relay the information between the base station and the AIoT device. The communication between the nodes may be bidirectional, allowing for data and/or signaling in both directions.

A UE may be configured to perform the functions of a reader or an intermediate UE. The UE may send an AIoT paging message an AIoT device to request information, such as during an inventory procedure. To respond to the request, the AIoT device may perform an access procedure. To enable AIoT devices to respond to requests and/or initiate communication with the UE, the access procedure may be defined.

Radio Frequency Identification (RFID) systems are Internet of Things (IoT) systems comprising two types of AIoT devices, referred to as “tags” and “readers” or “interrogators”. RFID devices have at least one antenna that is used by the AIoT device to communicate with each other using signals. Different applications may take advantage of an RFID system such as inventory control, containers tracking, patient monitoring, pet finding, and children tracking, to name a few.

As an example, in an inventory control system, an interrogator device (e.g., UE), may trigger multiple tag devices using a sequence of messages, to which the tag devices may respond to. In other words, the inventory procedure may comprise a single round of attempts of having each tag device respond or attempt to respond with its access ID or perform a random access procedure.

In an RFID access procedure, two AIoT devices may randomly select the same occasion, and the same random number, in which case a collision may occur. This is similar to the current 5G new radio (5G-NR) access procedure. However, for an AIoT system, it is expected that the number of AIoT devices (e.g., tags) will be extremely large, much larger than what we have in current wireless systems. To design an access mechanism for AIoT devices that is robust to a large number of AIoT devices, it may be desired to control the number of AIoT devices that access the access channel.

The UE (e.g., reader) may monitor access occasions and make an overload determination. Different configurations may be defined, each configuration having its own physical resources (time and frequency resources), modulation and coding scheme (MCS), reader transmission power, access occasions, transmission beam, or transmission configuration indication (TCI) states. Different configurations may target different AIoT devices, e.g., based on spatial differentiation. As an example, by changing the transmission power or beam direction, the coverage area may change, reaching a different subset of AIoT devices.

Each configuration may also be associated with a specific AIoT device group, and only AIoT devices belonging to that group may respond to the paging sent using the specific configuration. As an example, the configuration may be such that only a given percentage of the AIoT devices may respond, based on a probability of transmission, which may be indicated by the UE to the AIoT device in the paging message.

By tailoring the resources, in combination with targeting specific AIoT device groups, and using statistics from previous accesses, the UE may adjust the system in a dynamic fashion, every time a paging message is sent. This dynamically tailored load balancing process yields in an efficient random access procedure that may minimize collisions, thereby minimizing the overall system overhead, which is a great concern in dense AIoT systems.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates an example of a call flow of an inventory procedure using RFID devices;

FIG. 3 illustrates an example of call flows of two types of random access procedures that may be used in 5G New Radio (NR) systems;

FIG. 4 depicts the architecture of an example of a topology of an AIoT system-Topology 1;

FIG. 5 depicts the architecture of another example of a topology of an AIoT system-Topology 2;

FIG. 6 depicts the architecture of another example of a topology of an AIoT system-Topology 3;

FIG. 7 depicts the architecture of another example of a topology of an AIoT system-Topology 4;

FIG. 8 shows an example of parameters that may be associated with a random access time window;

FIG. 9 depicts an exemplary call flow for a capability request;

FIG. 10 illustrates the monitoring occasion relationship with a resource index;

FIG. 11 illustrates an example of collision occasions and successful occasions;

FIG. 12 illustrates the association between beam IDs and TCI-State IDs;

FIG. 13 illustrates an example of splitting of coverage area by adjusting transmission power;

FIG. 14 illustrates the response rate indication in the random access message;

FIG. 15 illustrates an example of a call flow of the AIoT random access procedure between the network, UE and the devices; and

FIG. 16 illustrates an example of the dynamic load balancing procedure.

### DETAILED DESCRIPTION

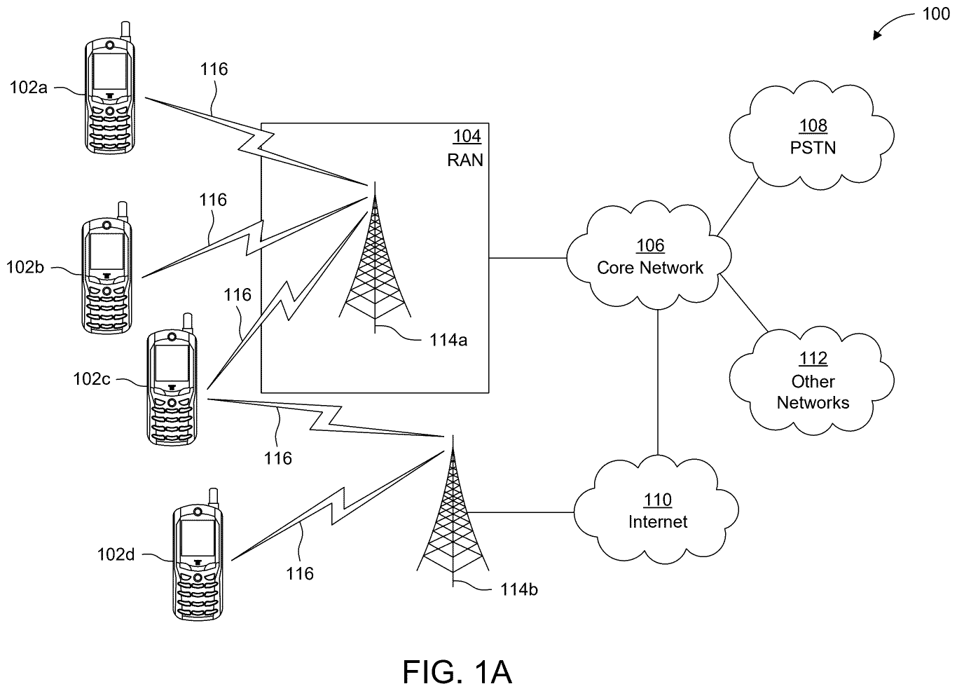

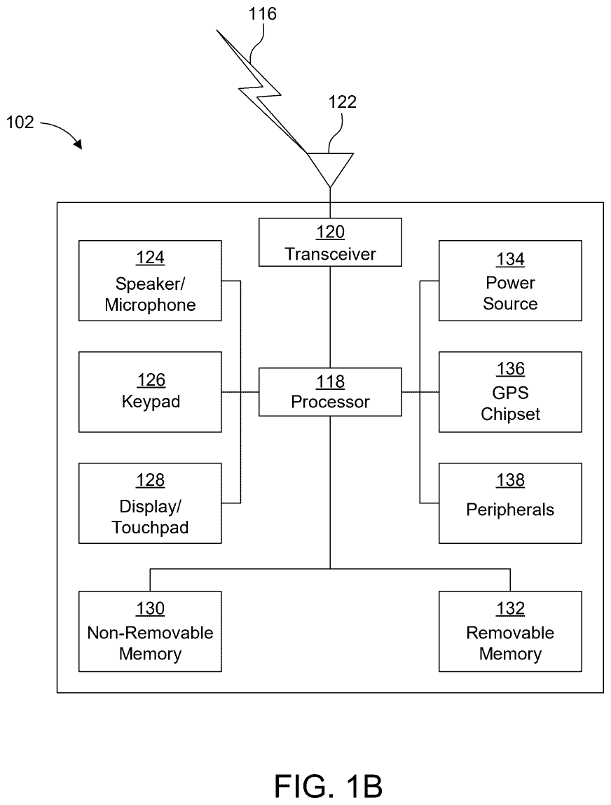

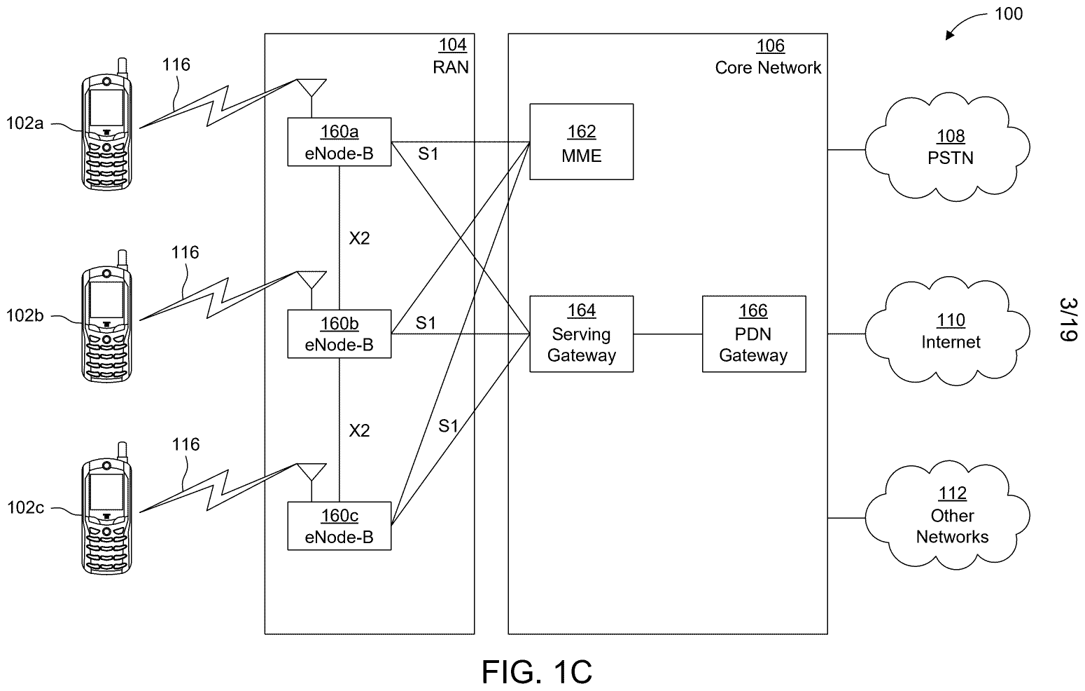

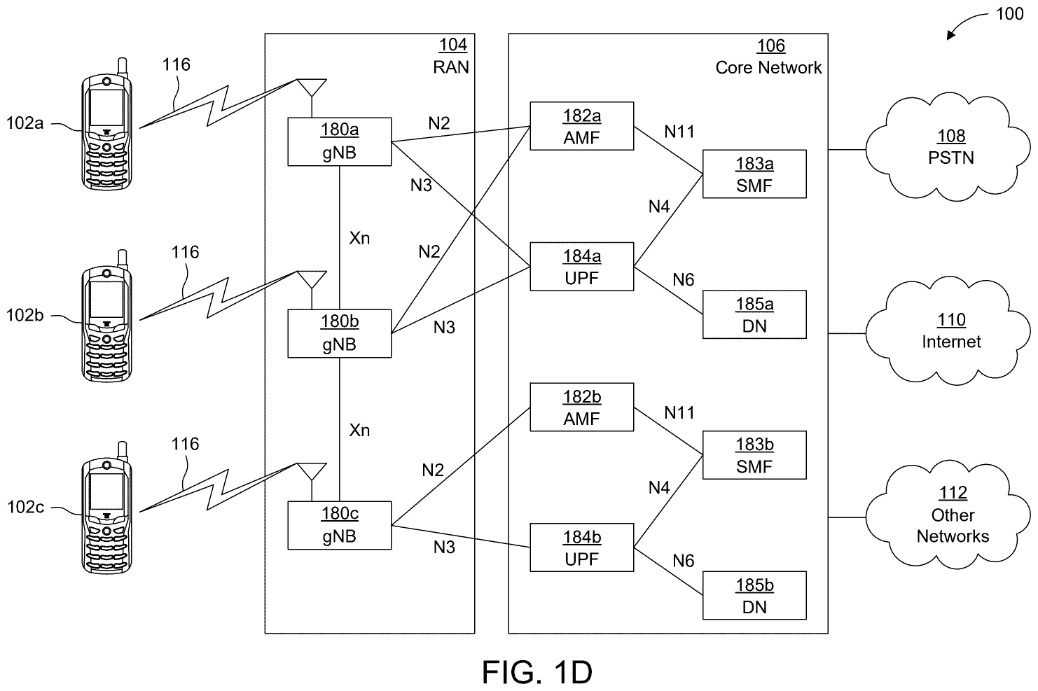

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other devices described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

In an AIoT (AIoT) system, an AIoT device, such as a tag, communicates with a reader or interrogator. The reader may be a UE. The tag may optionally communicate with an intermediate node, which may be a UE. The intermediate node may communicate with the base station, processing and/or relaying information associated with one or more AIoT devices. The reader or the intermediate node may have the capability of communicating directly with the AIoT device, over the AIoT interface, e.g., using RFID. The intermediate node may process and then relay the information between the base station and the AIoT device. The communication between the nodes may be bidirectional, allowing for data and/or signaling in both directions.

A UE may be configured to perform the functions of a reader or an intermediate node. The UE may page an AIoT device to request information, such as during an inventory procedure. To respond to the request, the AIoT device may perform an access procedure. To enable AIoT devices to respond to requests and/or initiate communication with the UE, the access procedure may be defined.

Radio Frequency Identification (RFID) systems are Internet of Things (IoT) systems comprising two types of devices, referred to as “tags” and “readers” or “interrogators”. RFID devices have at least one antenna that is used by the device to communicate with each other using signals. Different applications may take advantage of an RFID system such as inventory control, containers tracking, patient monitoring, pet finding, and children tracking, to name a few.

As an example, in an inventory control system, an interrogator device, may trigger multiple tag devices using a sequence of messages, to which the tag devices may respond to. In other words, the inventory procedure may comprise a single round of attempts of having each tag device respond or attempt to respond with its access ID or perform a random access procedure.

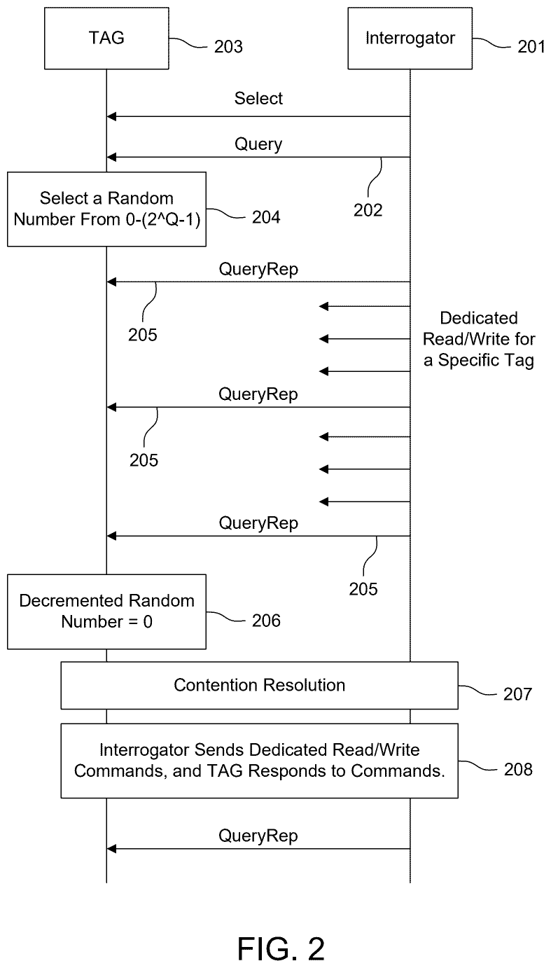

FIG. 2 illustrates an example of a call flow of an inventory procedure using RFID devices.

In the inventory procedure, an interrogator or reader 201 may send a Query message 202 to energize all or a subset of tags 203. Following the Query message 202, the tag 203 may select a random number from 0-2\hat{ }Q-1 204 and load its memory with that number. At each transmission of a QueryRep 205, the tag 203 decrements its counter until the counter reaches 0 206. When the counter reaches 0 206, the tag 203 may initiate a contention resolution procedure 207, which may include transmitting its device ID in the uplink, and waiting for confirmation of the device ID in the downlink (to address possible collision between multiple devices selecting the same random number). The interrogator (or reader) 201 may send multiple read/write commands 208 to a tag 203 that has passed the contention resolution, to which the tag may respond 208.

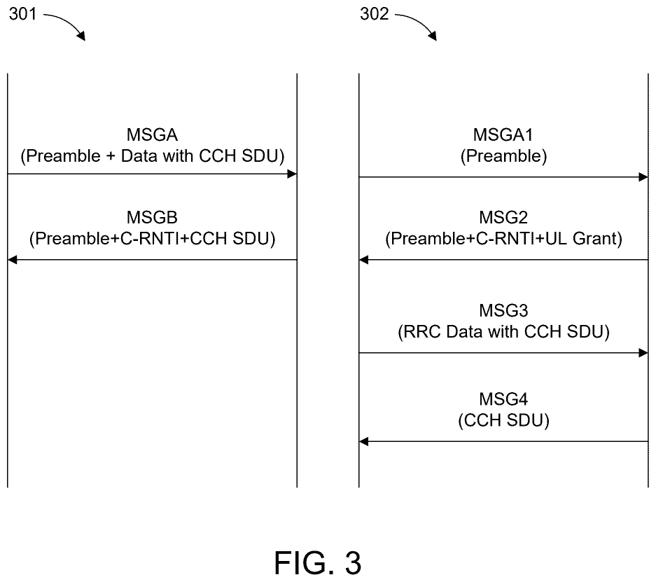

FIG. 3 illustrates an example of call flows of two types of random access procedures that may be used in 5G New Radio (NR) systems.

Random Access in 5G New Radio (NR) supports 2 types of random access procedures: 2-step 301 and 4-step 302 random access. A WTRU may decide between using 2-step 301 or 4-step 302 random access based on a number of factors.

A WTRU may decide between using 2-step 301 or 4-step 302 random access based on an RSRP threshold: If the cell level RSRP is above a threshold, the WTRU may use 2-step random access. The idea is that at cell center, 2-step random access may be sent because timing advance (TA) is minimal.

A WTRU may decide between using 2-step 301 or 4-step 302 random access based on history of previous attempts: If a number of 2-step procedures do not succeed, the WTRU may switch to a 4-step procedure. Specifically, the WTRU may be in cell center but the channel quality may not be sufficiently high to transmit data successfully.

A WTRU may decide between using 2-step 301 or 4-step 302 random access based on MSBB contents: If MSGB contains a fallback indication, and if the network is able to successfully decode the preamble, but not the data, then the procedure may continue as a 4-step random access procedure to recover the data after the TA is applied.

For AIoT, when a response is expected from multiple devices that are intended to be identified, an AIoT contention-based random access (CBRA) procedure may be initiated by the UE/reader. Additionally, for the CBRA procedure, slotted-ALOHA based access may be used, including either a 4-step or a 2-step procedure.

For the 4-step procedure, the following messages may be involved:
AIoT MSG1: the device sends an ID to the reader. The ID is a random ID generated by device.
AIoT MSG2: the reader echoes the random ID received in MSG1.
AIoT MSG3: the device sends an AIoT device ID (i.e., assigns a device ID to the AIoT device) and/or any other upper layer data to the reader (depending on upper layer request).
MSG4: This message may be transmitted by the reader for subsequently carrying data such as a command. Contention may already been resolved by MSG2.

For 2-step procedure, the following messages may be involved:
AIoT MSG1: The device sends a AIoT device ID and/or any other upper layer data (depending on upper layer request). The AIoT device ID is an ID that was previously assigned by the reader.
AIoT MSG2: The reader may echo some information from MSG1 (e.g., the device ID).

Different network topologies may be defined for an AIoT system.

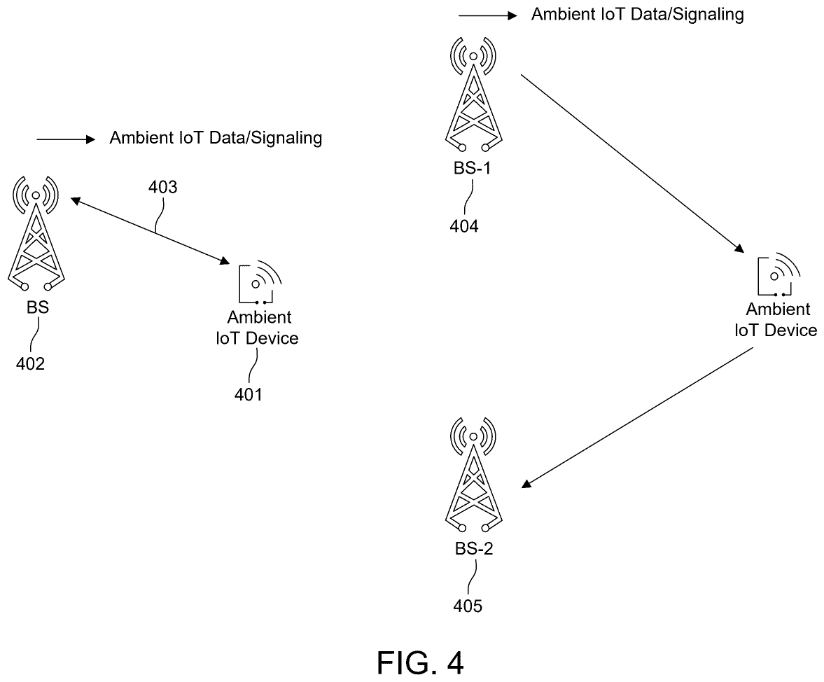

FIG. 4 depicts the architecture of an example of a topology of an AIoT system—Topology 1.

In topology 1, the AIoT device 401 may communicate with a base station (e.g., gNB, eNB) 402. The communication between the base station and the AIoT device may include data and/or signaling over the AIoT interface 403. In one example, the communication may be bidirectional, with one base station supporting the bidirectional communication. In another example, the communication may involve two base stations 404, 405, one base station 404 may be transmitting to a given AIoT device and another base station 405 may be receiving 405 from the same AIoT device.

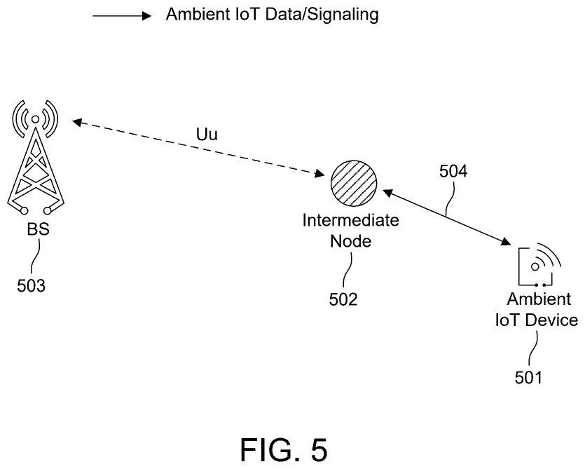

FIG. 5 depicts the architecture of another example of a topology of an AIoT system—Topology 2.

In topology 2, the AIoT device 501 may communicate with an intermediate node 502, and the intermediate node 502 may communicate with the base station 503. The intermediate node 502 may be, for example, a relay, an IAB node, a UE, an WTRU, or a repeater. The intermediate node may be referred to as intermediate WTRU. The intermediate WTRU 502 may have the capability of communicating with the base station (e.g., over the Uu interface) and of communicating directly with the AIoT device 501, over the AIoT interface 504 (e.g., using RFID). The intermediate WTRU 502 may process and then relay the information between the base station 503 and the AIoT device 501. The communication between the nodes may be bidirectional, allowing for data and/or signaling in both directions.

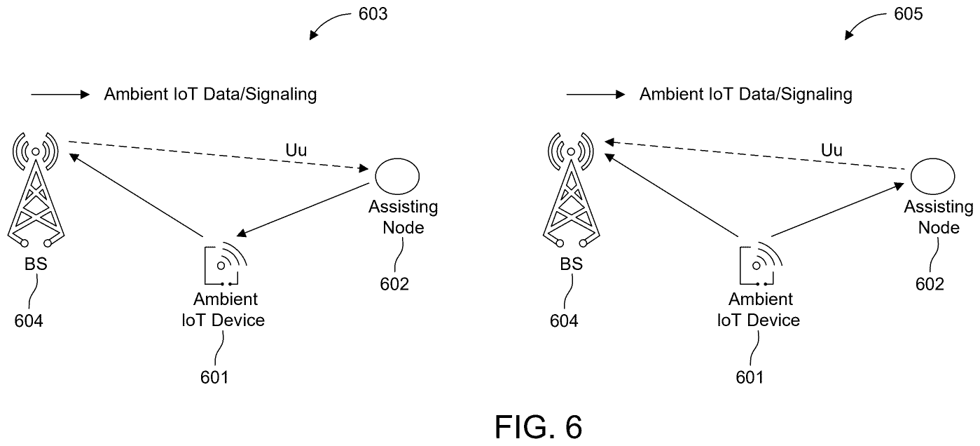

FIG. 6 depicts the architecture of another example of a topology of an AIoT system—Topology 3.

In topology 3, the AIoT device 601 may communicate using an assisting node 602. The assisting node 602 may be for example, a WTRU, a relay, an IAB, an UE, a repeater. The assisting node may be capable of AIoT communication. In one example, the assistance may be a downlink assistance 603. In the downlink assistance model, the AIoT 601 device may transmit data and/or signaling to the base station 604, and receive data and/or signaling from the assisting node 602. In another example, the assistance may be an uplink assistance 605. In the uplink assistance model, the AIoT device 601 may receive data and/or signaling from a base station 604 and transmit data and/or signaling to the base station and to the assisting node 602.

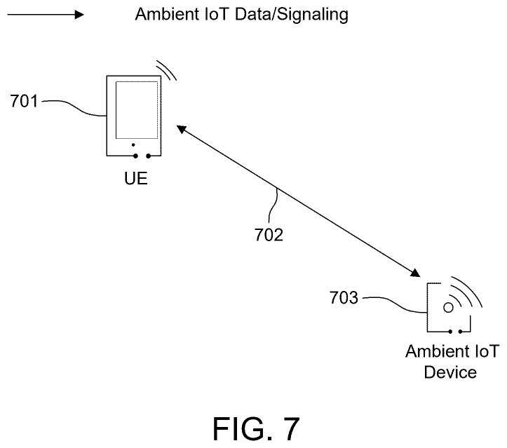

FIG. 7 depicts the architecture of another example of a topology of an AIoT system—Topology 4.

In topology 4, the AIoT device 701 communicates bidirectionally 702 with a UE 703. The communication between UE and the AIoT device includes AIoT data and/or signaling.

### Terminology

A “UE” may refer to the reader or interrogator or an “intermediate UE” from the AIoT topology 2 and may be used interchangeably with “reader” or “TRP” or “gNB” or any other entity (e.g., RAN entity) that can transmit and or receive the signals and messages (e.g., data signals, control messages, etc.) with the device or the AIoT device.

A “TRP” may be used interchangeably with “gNB”.

A “network” may refer to gNB/AMF/UPF/LMF, e.g., radio access network (RAN) or core network (CN).

The terms “pre-configuration” and “configuration” may be used interchangeably. The terms “configuration” or “pre-configuration” may refer to any configuration received by a message (e.g., an RRC message, a MAC CE, a PHY layer signal, a data PDU, a control PDU associated with any existing or new protocol layer) received from either a network node, or from another device or UE or WTRU. The term pre-configuration may refer to the process of pre-provisioning information is a device or UE or WTRU.

The term “IDs” may be used interchangeably with index/indices.

Random access procedure and/or contention based random access procedure and/or contention free random-access procedure and/or inventory procedure and/or query procedure and/or any other procedures for involving a reader (e.g., TPR, UE) acquiring and/or reading and/or determining the IDs (e.g., random IDs, temporary IDs, permanent IDs, etc.) from the devices (e.g., of one or more AIoT devices) may be interchangeably used.

A “resource ID” may be interchangeably used with a “configuration ID”, “session ID”, “sub-session ID” or any other terms intended to indicate a set of resources (e.g., time, frequency) and/or other parameters for transmission, processing and/or reception of messages, signals, etc. to and from the devices.

The term “occasion” refers to the opportunity for device transmission that may be delimited by the transmission of a query rep message (or similar). Specifically, a device may perform transmission in an occasion by performing a AIoT transmission in a defined time following the query rep associated with that transmission. Alternatively, an occasion may comprise both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

A “collision occasion” may refer to an time and/or frequency occasions where the UE may receive the signals and/or messages (e.g., random IDs, device IDs) from the AIoT devices but may not be able to decode the IDs.

An “idle occasion” may refer to time and/or frequency occasions where the UE does not receive any signals or messages from the devices.

Any reference to “time” may indicate an absolute time measurement (e.g., seconds, slots, frames) or it may indicate a number of executions of a procedure, possibly triggered by a reader (e.g., number of inventory procedures, number of accesses or RACH procedures). Alternatively, it may indicate a number of messages, possibly of a specific type, or containing specific information, received or transmitted.

A “resource ID” may be interchangeably used with a “configuration ID”, “session ID”, “sub-session ID” or any other terms intended to indicate a set of resources (e.g., time, frequency) and it may include other parameters used for transmission, reception and processing of messages and signals to and from the devices.

An “AIoT (AIoT) device” or a “device” may refer to a device (e.g., IoT device) that may be able to transmit and/or backscatter and/or receive data/IDs and/or control signals to and/or from RAN entities (e.g., gNB, UE, network etc.).

Device 1: This type of device has ˜1 μW peak power consumption without either DL or UL amplification in the device. The device's UL transmission capability is mostly backscattering on a carrier wave provided externally.

Device 2a: This type of device is similar the Device 1 except that it may use DL and/or UL amplification. The device's UL transmission capability, similarly to device 1, is mostly backscattering on a carrier wave provided externally.

Device 2b: This type of device a has a capability of a few hundred uW peak power consumption, both DL and/or UL amplification in the device. This type of device may also have signal generation capabilities.

All the devices may be able to receive and demodulate data and control messages from different RAN entities (e.g., from gNB, UE, network, etc.). The device capability may be one of as categorized by 3GPP to date (e.g., device 1, device 2a, device 2b) or any other IoT device that may at least have one or more combinations of the capabilities as described above.

In a dense AIoT system, with a UE is configured as a reader or interrogator, and the UE interrogating the many devices (e.g., tags), when the devices respond to an interrogation (e.g., paging message), they may respond in overlapping times, in which case their transmissions may collide. In one example, the UE may monitor access occasions and make an overload determination. Different configurations may be defined, each configuration having its own physical resources (time and frequency resources), modulation and coding scheme (MCS), reader transmission power, access occasions, transmission beam, or transmission configuration indication (TCI) states. Different configurations may target different AIoT devices, e.g., based on spatial differentiation. As an example, by changing the transmission power or beam direction, the coverage area may change, reaching a different subset of AIoT devices.

Each configuration may also be associated with a specific AIoT device group, and only AIoT devices belonging to that group may respond to the paging sent using the specific configuration. As an example, the configuration may be such that only a given percentage of the AIoT devices may respond, based on a probability of transmission, which may be indicated by the UE to the AIoT device in the paging message.

By tailoring the resources, in combination with targeting specific AIoT device groups, and using statistics from previous accesses, the UE may adjust the system in a dynamic fashion, every time a paging message is sent. This dynamically tailored load balancing process yields in an efficient random access procedure that may minimize collisions, thereby minimizing the overall system overhead, which is a great concern in dense AIoT systems.

In one example, a UE (e.g., the reader or interrogator) may receive configuration and assistance information from the network. Configuration information may be associated with the air interface resources used for transmission or reception, such as time and frequency resources. Assistance information may be additional information that may be used to assist the UE in determining some additional parameters for transmission or reception. The objective is to tailor the transmission or reception using the additional parameters.

In the examples described to explain the solution concepts, configuration information and assistance information may be sent in separate messages and different parameters may be sent at different occasions. However, these are a non-limiting examples, as one with ordinary skill in the art understand that the configuration and assistance information could be sent in any number of messages, and the parameters in each message may vary depending on the target use case and the system architecture being used.

Resource IDs may be associated with a given set of parameters sent the assistance information and they may have one to one, one to many or many to one relationships. For instance, an assistance information ID may be associated with one or more resource IDs.

In one example, the assistance information may be divided in first assistance information and second assistance information. The first assistance information may be sent in the beginning of the procedure, together with the configuration message, or in a separate message. When the UE detects overload and notifies the network of an overload condition, the network may send second assistance information, which may include more restrictions with the intent of minimizing the probability of a continues overload condition in future device access attempts.

In one example the first and second assistance information comprise different load balancing parameters. In another example, the first and second assistance information comprise the same load balancing parameters and the second assistance information may be an update of the parameters sent in the first assistance information. In one example, the first and second assistance information may be associated with the same resource ID. In another example, the first and second assistance information may be associated with different resource IDs.

Maybe we can mention that the second assistance information may also consist of one or more information(s) included with first assistance information.

The assistance information may assist the UE in reducing device overload and associated collisions during a device access procedure. The UE may receive, as part of the configuration and assistance information, resource configuration (e.g., time and frequency resources) for random access procedure with a target number of devices to access, where each target number is associated with at least one of the following: resource IDs, Tx power, Tx beam, response rates, device group (e.g., device type, energy level threshold, mobility status, etc.).

The devices may have been preconfigured with specific parameters from the assistance information associated with each resource ID.

In one example, the UE may initiate a random access procedure for devices by broadcasting a resource ID to be used, the determined number of access occasions, the response rate, the device group with the associated Tx power and Tx beam. The UE may broadcast the resource ID and any other parameters from the assistance information that were not preconfigured in the devices. The devices may then use the resource ID to determine the configuration and the assistance information parameters, and also use the other parameters broadcasted. For example, the UE may broadcast a specific device group to respond. The UE may receive responses from the devices and determine a collision occasion occurred if it receives a message but it is unable to decode the received message in an occasion.

In one example, the UE may determine the random-access parameters to use (e.g., number of access occasions) for each resource ID based on the assistance information and the previous resource IDs used. The UE may consider the previous resulting number of collisions, number of devices that successfully accessed, total number of access occasions, or similar resulting statistics associated with the previous access attempts success and/or failure.

In one example, the UE may terminate the procedure for the resource ID if the number of (e.g., consecutive) collision occasions is above a threshold, or the number of accessed devices is above the target number of device to access, or the maximum number of access occasions is elapsed (i.e., all access occasions are used). The UE may indicate the termination to the devices and report to the network the successful accessed device IDs after all resource IDs have been terminated.

The dynamic overload process may enable the reader (e.g., the UE, TRP) to determine and resolve the overload in the random-access procedure. The solution enables the ability to send a random access indication to a subset of devices, based on different criteria, yielding in an efficient random access procedure that minimizes collisions thereby minimizing the overall system overhead.

A UE (e.g., the reader) may be able to transmit messages (e.g., downlink signals, control messages etc.) to one or more devices. The control messages may comprise configuration, indications, acknowledgement message (ACKs), negative acknowledgement message (NACKs), and/or other control messages to control the transmission, reception and/or other behaviors of the devices. The data messages may comprise the data such as, UE IDs, request for information, etc.

A UE may transmit data and control messages as separate messages, each characterized by a transmission in separate time, frequency occasion and/or in different channels. In another example, a UE transmit the data and control messages together on the same time/frequency occasion and/or in the same channel. For instance, the UE may transmit a message comprising part control message (e.g., as preamble, mid-amble, post-amble, part of message) and part data message, in the same transmission occasion.

A UE may transmit both the control messages and data signals in the same channel. The UE may transmit control messages in a control channel (e.g., channel dedicated transmission and reception of a control signal) and data message in a data channel (e.g., channel dedicated to transmission and reception of a data signal). These transmissions may be in the same or different time/frequency occasions.

A UE may transmit DL messages to the device in the DL physical data channel (e.g., PDSCH, PDCCH, etc.). Optionally, a UE may transmit DL messages via lower or higher layer signaling (e.g., DCI, MAC-CE, RRC or LPP message) (e.g., as defined by 3GPP) or via device specific (e.g., PDRCH) physical channels or higher or lower layer signaling specific to DL “reader to device” channels.

A UE may receive messages from a device with data generated by the device, such as device IDs, device capabilities, device data (e.g., sensor data), device information (e.g., type of device, available energy etc.).

A UE may receive UL messages from the device in the NR UL physical channel (e.g., PUSCH, PUCCH, etc.) or via lower or higher layer signaling (e.g., DCI, MAC-CE, RRC or LPP message) or via newly defined physical channels or higher or lower layer signaling specific to “device to reader” (e.g., PDRCH) channels.

A UE may receive configuration information from the network.

A UE may receive one or more sets of configuration information for the random-access procedure for AIoT devices, from the network, via downlink physical channel (e.g., PDSCH, PDCCH, etc.) or via lower or higher layer signaling (e.g., DCI, MAC-CE, SIB, RRC or LPP message).

The configuration information may comprise resource IDs. Resource IDs represent a specific configuration (i.e., set of parameters) for a resource being used. A resource ID is equivalent to a configuration ID. The UE may receive one or more sets of resource IDs, e.g., as an identifier, to identify the configuration and associations with other parameters. The UE may be configured to determine the resource IDs. The UE may determine based on at least one of the following as the resource ID: Random ID, Temporary, or permanent UE IDs (e.g., RNTI value).

The configuration information may comprise time resources. Time resources may include absolute start and end times (e.g., in terms of symbol index, slot index, sub-frames index, frames index, absolute time, etc.). Time resources may include time duration (e.g., in terms of number of symbols, slots, frames, subframes, milliseconds, seconds). Time resources may include time offset (e.g., in terms of number of symbols, slots, frames, subframes, milliseconds, seconds, relative time with respect to a reference time).

The UE may receive a reference time (e.g., for time offset) via a configuration from the network; or an indication (e.g., DCI, MAC-CE) from the network; or an offset with respect to the reference system frame number (SFNO) time. The UE may receive one or more sets of time resources, each associated with different resource IDs. The UE may receive a time resource associated with one or more resource IDs.

The configuration information may comprise frequency resources. Frequency resources may include bandwidth (e.g., in terms of number of resource elements (REs), number of resource blocks (RBs), bandwidth part (BWP), frequency layers (e.g., PFLs), Hertz (Hz)). Frequency resources may include a start frequency and an end frequency (e.g., in terms of RE index, RB index, Hz). Frequency resources may include a frequency offset (e.g., in terms of number of REs, number of RBs, Hz, relative to a reference frequency); or sub-carrier spacing (e.g., in terms of number of REs, number of RBs, Hz).

The UE may receive a reference for the frequency for frequency offset (e.g., ARFCN). The UE may receive one or more sets of frequency resources, each associated with different resource IDs. The UE may receive a frequency resource associated with one or more resource IDs.

The configuration information may comprise first assistance information.

The UE may be configured by the network with one or more sets of first assistance information for the AIoT random-access procedure via downlink physical channel (e.g., PDSCH, PDCCH) or via lower or higher layer signaling (e.g., DCI, MAC-CE, SIB, RRC or LPP message) from the network.

The first assistance information may comprise an assistance information ID. The UE may receive an ID associated with each set of assistance information. The assistance information IDs may be associated with one or more resource IDs.

The first assistance information may comprise a random access time window. The UE may receive one or more random access time windows indicating the time duration prioritizing the AIoT random-access procedure and/or reserving of the resources, including an access window ID.

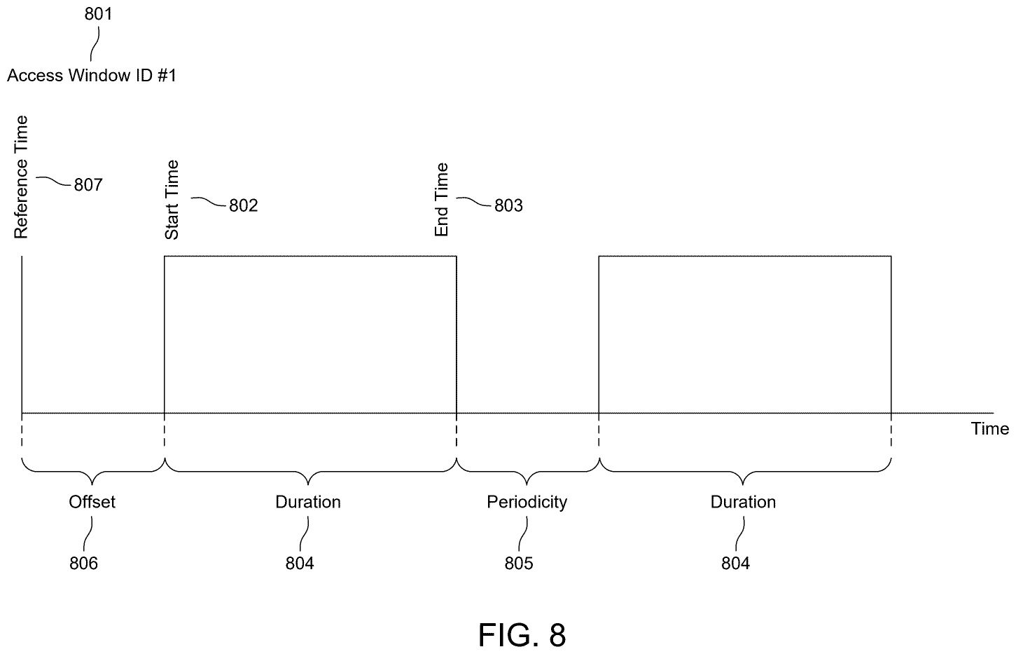

FIG. 8 shows an example of parameters that may be associated with a random access time window.

For a given access window ID (e.g., access window #1) 801, the parameters may include a start time 802 and an end time 803 (e.g., in terms of symbol index, slot index, frame index, subframe index, absolute time), which define a window duration (e.g., in terms of the number of symbols, slots, frames or subframes or milliseconds, seconds.) 804. The parameters may also include a periodicity (e.g., in terms of number of symbols, slots, frames and/or subframes) 805 and a time offset (e.g., in terms of number of symbols, slots, frames or subframes, or milliseconds, seconds) 806. Each set of parameters may be associated with one or more resource IDs or access window IDs.

Events/conditions that may activate or deactivate a time window, includes, for instance, an indication from the network, UE mobility, or reference time (e.g., for time offset) 807. This may be a time instance when the UE receives an indication from the network, a time instance when the UE receives random access configuration, or an offset with respect to SFNO time.

The first assistance information may comprise parameters associated with the random-access procedure. The parameters associated with the random-access procedure may include a number of time occasions (e.g., Q-value); a number of frequency occasions; a maximum transmission power; a time occasion type (e.g., periodic, semi-persistent, aperiodic). The information may indicate whether the time occasions should be indicated to the devices (e.g., true, false). The parameters associated with the random-access procedure may also include trigger conditions associated with the time occasion type. For instance, trigger conditions to transmit a time occasion indication to the devices for semi-persistent, aperiodic type.

Optionally, the UE may determine the parameters (e.g., number of occasions) for the random-access procedure based on other information configured. For instance, the UE may check is the time resource configured (e.g., time duration, duration of time window, difference between absolute start and end time) is above a (pre) configured threshold. In another example the UE may check if the frequency range configured (e.g., bandwidth, difference between the end and start frequency) is above a (pre) configured threshold. Or the UE may check if the target number of devices to be accessed (e.g., inventoried) configured is above a (pre) configured threshold.

The first assistance information may comprise reader to device (R2D) and/or device to reader (D2R) modulation and encoding. The UE may receive an indication of the reader to device (R2D) modulation (e.g., amplitude shift keying (ASK), on-off keying (OOK) and/or encoding methods (e.g., Manchester encoding). The UE may receive the device to reader (D2R) modulation (e.g., ASK, OOK) and/or encoding methods (e.g., FMO encoding, Miller encoding).

The first assistance information may comprise UE and device transmission timings. The UE transmission timing may include a time duration or a range (e.g., minimum time, maximum time) for the UE between: two consecutive R2D transmissions; an R2D reception and a D2R transmission; a reception of messages, configuration, or indications from the network (and/or TRP) and R2D transmission; or a reception of messages, configuration information, indications from the network (and/or TRP) and D2R reception.

The device transmission timing may be defined as the time duration or a range (e.g., minimum time, maximum time) for the devices between two consecutive D2R transmissions, or a D2R reception and R2D transmission. The time may be configured or determined in terms of number of OFDM symbols, slots, frames, subframes, chip duration.

The UE may determine the transmission timing (e.g., for UE and/or device transmission timings) based on

The time duration (e.g., in terms of number of symbols, slots, frames, subframes, duration of the access window, etc.) for the random-access procedure is above a (pre) configured threshold;

The target number of devices to access is below a (pre) configured threshold; or

The number of occasions (e.g., time, frequency) is above a (pre) configured threshold, etc.

The first assistance information may comprise a target maximum number of devices to access a resource. Optionally, the UE may determine the target number of devices to access a resource based on the number of time and/or frequency occasions (e.g., associated with the resource), or the UE capability to inventory and/or access the number of devices.

The first assistance information may comprise other reader's information. The other readers information may include the number of other readers in proximity of the UE, the reader IDs (e.g., UE IDs) of the readers in proximity, or the reader's locations.

The assistant information may be associated with a resource ID. A resource ID may be associated with one or more combinations of the assistance information (e.g., ID), including at least one of the following: assistance information ID; access time window (e.g., ID); frequency resources (e.g., start frequency, end frequency, bandwidth, frequency offset); time resources (e.g., absolute start and stop times, time offset).

The UE may provide its reader capabilities to the network.

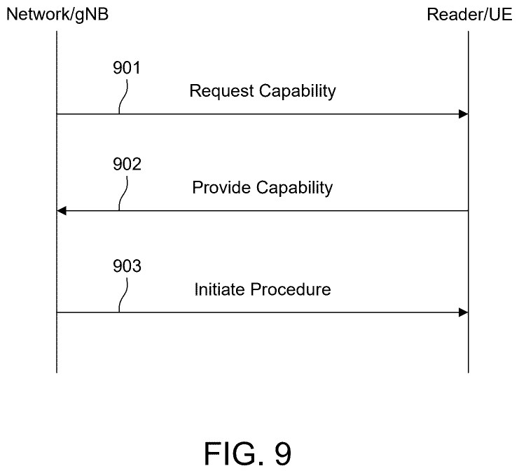

FIG. 9 depicts an exemplary call flow for a capability request.

The UE may receive an indication from the network to transmit its capability 901. The UE may reply with a capability indication 902. Optionally, the UE may transmit the capability unsolicited.

The UE capability information may include its capability to transmit and receive AIoT messages and/or control signals (e.g., through PDRCH and/or PRDCH).

The UE capability information may include its capability to transmit and receive AIoT messages for random access (e.g., receive messages, IDs, echo messages, IDs).

The UE capability information may include its supported frequency bands for the AIoT procedures (e.g., frequency range (e.g., in RE index, RB index, Hz), bandwidth).

The UE capability information may include its capability to receive, access and inventory the device IDs, e.g., supported number of device IDs the UE can inventory and store, or supported time duration (e.g., in terms of number of symbols, slots, frames, subframes, milliseconds) for which it can store the acquired device IDs.

The UE capability information may include its capability to perform and report measurements (e.g., on AIoT signals that may be transmitted or backscattered, supported number of device IDs the UE may report).

The UE capability information may include its transmission timing capability (e.g., minimum time between to R2D transmissions, a D2R reception and a R2D transmission).

The UE capability information may include its capability to transmit with one or more sets of transmission power (e.g., minimum transmission power, maximum transmission power, set of transmission powers, in terms of dBm, watt).

The UE may receive an acknowledgement or an indication after transmitting the capability information. This acknowledgement may be, e.g., a trigger for the UE to initiate the random-access procedure.

The UE may initiate a random access procedure. The UE may be configured by the network to initiate a random-access procedure. The UE may determine to initiate the first procedure based on receiving an indication from the network for initiating the random-access procedure (e.g., resource ID, assistance information ID, access window IDs, etc., via DCI, MAC-CE) 903.

The UE receives random access configuration information from the network. The UE may send (e.g., broadcast) the configuration information to the devices. The UE may transmit the configuration information from the network, or the information determined by the UE, to the devices. The configuration information may be associated with one or more resource IDs. The UE may transmit the messages with the maximum transmission power.

The UE may explicitly transmit at least one of the configuration information as a R2D message. The UE may implicitly indicate the parameters to the devices. For example, the UE may associate one or more parameters of the message (e.g., message sequence, length, duration, encoding used, preamble, midamble, postamble) with one or more configuration parameters and broadcast it to the devices. The UE may use a combination of the explicit and implicit indications to transmit the configuration message to the devices.

The UE may be configured to transmit an occasion (e.g., time occasion) indication to the devices. The UE may determine the occasions where the devices may transmit based on the number of occasions (e.g., time occasions) indicated to the devices. The UE may determine the occasions where the devices may transmit based on the total duration (e.g., associated with the configuration for a resource ID, access time window duration). The UE may determine the occasions where the devices may transmit based on the time occasion type (e.g., periodic, aperiodic, semi-persistent). The UE may determine the occasions where the devices may transmit based on the device transmission timings. The UE may determine the occasions where the devices may transmit based on the UE transmission instance (e.g., time instance where the UE transmits a message, signal and/or an indication to the devices). The indication may be a time occasion indication.

The UE may determine to indicate the transmission occasions (e.g., time occasions) to the devices. The UE may receive the random-access messages (e.g., MSG 1, MSG3) from one or more devices in one or more occasions. The UE may also not receive any random-access messages in one or more occasions.

### Device Configuration for Random Access

In one example, the device may be configured to monitor the D2R channel (e.g., PDRCH) for random access indications (e.g., configuration, resource IDs). The device may be configured with periodic, aperiodic or semi-persistent monitoring. In one example, for each monitoring instance, the device may be configured with a fixed duration of time (e.g., in milliseconds) for monitoring.

The device may receive at least one of the following configuration information and/or assistance information from the UE: Reader ID (e.g., UE ID), resource IDs, relationship between the resource IDs, order or resource IDs, time resources, frequency resources, access time window configuration (e.g., access window ID, start time, stop time, etc.), modulation and/or encoding for R2D and D2R messages, number of time occasions (e.g., Q-value), number of frequency occasions, time slot indication (e.g., indicated by the UE, determined by the device), R2D and/or D2R transmission timings, transmission power, transmission beam, Other reader IDs (e.g., UE IDs, TRP IDs, associated configuration ID, session ID, sub-session ID), response rates, device group indication, number of collisions, or number of target devices.

Upon access initiation, the UE may send the resource ID configurations to the devices. This may be included in the paging message itself, or may be sent previously. The device may receive the configuration from one or more readers. After receiving the random-access configuration from the network, the device may determine to associate with at least one of reader IDs and/or resource IDs based certain criteria.

The device may determine its association based on received power. The device may be configured to measure the power (e.g., RSRP, RSSI, SINR, RSRQ) of the received message (e.g., random access configuration). In one example, the device may determine the measurements based on a known reference sequence or signal transmitted (e.g., as a part) of the indication (e.g., preamble, postamble, midamble). The device may determine to associate with the reader and/or a resource if the measurement is above a (pre) configured threshold.

The device may determine its association based on device group indication: The device may receive a group indication from the UE. In one example, the device may receive one or more thresholds associated with the group indications from the UE. In one example, the device may determine to associate with a reader and/or a resource if at least one or a combination of the indicated criteria and conditions is fulfilled.

For example, if the criteria associated with the configuration is device type 1, only the device of type 1 may respond to the access indication. If the criteria is energy level, the device may only respond to the access indication if its energy level is above a (pre) configured threshold.

The device may determine its association based on response rate. The device may receive response rate in the received message (e.g., random access configuration). The device may generate a random number and may respond to the random-access request if the probability of the generated number is below the response rate (e.g., in percentage). For example, the device may respond to a configuration of with 5% response rate if it generates number between 1 and 5 when generating a random number between 1 to 100.

The device may determine its association based on indicated statistics. The device may receive the statistics from the UE associated with one or more reader IDs and/or resource IDs. For example, the device may receive at least one of the following: number of accessed devices, number of collisions, number of idle occasions, the (e.g., average, median, variance) of measurements (e.g., RSRP, SINR, RSSI, RSRQ), or the (e.g., average, median, variance) of reference measurements.

The device may determine to respond to the random-access indication from the reader associated with the indicated resource if at least one or more combinations of the indicated statistics is above a (pre) configured threshold.

The device may determine its association based on the selection of reader IDs and/or resource IDs. In one example, the device may receive configuration associated with one or more reader IDs, resource IDs. In one example, the device may receive a set of reader IDs and associated information (e.g., reader location, parameters for random access procedure, time windows). In one example, the set of reader IDs may be associated with the same resource IDs.

The device may select a reader ID (e.g., from the indicated set) based on the reader with distance to the device being below a (pre) configured;

The device may select a reader ID (e.g., from the indicated set) of the reader associated with the received power (e.g., RSRP, RSSI, SINR, RSRQ etc.) of the message (e.g., configuration message, reference signal.) is above a (pre) configured threshold;

The device may select a reader ID (e.g., from the indicated set) of the reader whose message (e.g., configuration) is received first by the devices;

The device may select a reader ID (e.g., from the indicated set) of the reader with the indicated number of collisions below a (pre) configured threshold;

The device may select a reader ID (e.g., from the indicated set) of the reader with the indicated number of idle slots above a (pre) configured threshold.

The device may select a reader ID (e.g., from the indicated set) of the reader with the number of target devices to access above a (pre) configured threshold.

In one example, the device may select one or more resource IDs for random access based on at least one of the following: The associated configuration, e.g., the number of associated occasions (e.g., time occasions, frequency occasions, is above a (pre) configured threshold), the time window duration (e.g. above a (pre) configured threshold), the associated order (e.g., the device may pick the first or the last) the associated start time and/or end time; or the received power (e.g., RSRP, RSSI, SINR, RSRQ etc.) of associated with the message (e.g., configuration message, reference signal, etc.) is above a (pre) configured threshold; or the number of collisions, idle occasions, and/or number of devices accessed (e.g., in other (previous) resources)

In one example, the device may only respond to one reader and or resource in one time instance. In one example, the device may dissociate with an associated reader IDs and/or resource IDs based on at least one of the following:
The device may receive at least one or a combination of indications from the UE, e.g., indication of termination of a configuration, session, sub-session, indication to turn off the inventory flag, indication to select other readers, resources, backoff indication, indication to activate and/or deactivate a resource ID, reader ID; or the number of (e.g. consecutive) unsuccessful response (e.g., collisions) (e.g., associated with a reader ID, resource ID) is above a (pre) configured threshold; or the measurements (e.g., RSRP, RSRQ, RSSI, SINR) associated with the messages (e.g., associated with a reader ID, resource ID) is below a (pre) configured threshold.
The device may receive an indication to not inventory. In one example, the device may receive indication to not respond to other random-access procedure, e.g., after successfully being inventoried or after successfully accessing the device.
The indication may be to not respond until the termination message for a reader and/or resource;
The indication may be to not respond until an indicated time (e.g., in terms of number of time occasions, number of symbols, slots, frames, sub-frames). The device may receive an indication to start the timer (e.g., after an indication, e.g., after successful random access). The time may also be the backoff timer; or
The indication may be to not respond until an indication from the UE, e.g., indication to turn off the inventory flag.

In one example, the device may respond to other random-access procedures after the conditions indication is satisfied or terminated.

The device may receive a backoff timer indication. In one example, the device may receive a backoff timer indication (e.g., in terms of time occasions, number of slots, symbols, frames, subframes, milliseconds) from the UE. The device may receive an activation indication from the UE and may start the timer. When the timer is activated, the device may stop any transmissions and/or receptions, terminate the random-access session/sub-session, respond to random-access configuration/message associated with other readers or resources, e.g., the other reader and/or resource IDs may be indicated to the device by the UE.

The device may transmit the number of unsuccessful occasions to the UE. In one example, the device may be configured to transmit the number of unsuccessful occasions, i.e., the occasions where the device transmits the ID (e.g., random ID, device ID) without receiving the echo of the transmitted IDs from the reader. In one example, the device may transmit the number of unsuccessful occasions associated with the reader IDs and/or resource IDs.

The device may terminate the random-access procedure. In one example, the device may determine to terminate the random-access procedure when
The device receives an indication (e.g., echo, ACK) of the transmitted IDs (e.g., random ID, device ID);
The device determines termination of the sessions;
The device receives an indication from the UE (e.g., backoff timer, indication to terminate); or
The number of (e.g., consecutive) transmission occasions by the device is above a (pre) configured threshold.

The UE may receive responses from the devices. The UE may receive the responses to the random-access indication and/or occasion indication from one or more devices in one or more occasions. The response message from the device (e.g., MSG1) may include random IDs or device IDs;

The response message from the device (e.g., MSG1) may include the number of previous access attempts. For example, the message may include the number of previous occasions where the device unsuccessfully attempted to access the UE. The number of access attempts may be associated with one or more resource IDs and/or reader IDs which may also be additionally indicated by the devices.

The response message from the device (e.g., MSG1) may include an access attempt occasion. For example, the message may include the occasions (e.g., time occasion, frequency occasion) where the device made the unsuccessful attempt to access the reader or the UE. The access attempt occasions may be associated with one or more resource IDs and/or reader IDs which may be also be additionally indicated by the devices.

The UE may monitor for overload event and report to the network.

The UE may be configured to determine an event of overload of devices. The UE may determine the event either during a procedure (e.g., in one of the occasions during the procedure) or at the end of a procedure (e.g., after terminating the random-access procedure, e.g., for a resource ID).

The UE may be configured with a set of monitoring occasions, i.e., the occasions the UE may monitor and make an overload determination on, including at least one of the following. The configuration may include the resource IDs to monitor. The configuration may include the number of occasions to monitor, such as number of time occasions to monitor, number of frequency occasions to monitor.

The configuration may include the frequency occasions to monitor, such as the frequency indices to monitor (e.g., in terms of frequency occasion index, RE index, RB index, Hz), frequency range to monitor (e.g., start frequency, end frequency) (e.g., in terms of RE index, RB index, Hz, frequency occasion index.).

The configuration may include the time occasions to monitor, such as time occasions indices (e.g., in terms occasion indices, symbol indices, slot indices, frame indices, sub-frame indices), absolute time range (e.g., start time, end time, in terms of time occasion index, symbol index, slot index, frame index, sub-frame index), time duration with respect to a reference (e.g., in terms of number of time occasions, number of symbols, slots, frames, subframes) where the reference may be a reference resource ID configuration time, or a reference time instance (e.g., SFNO, current time).

The monitoring occasions may be occasions that occurred in the past, e.g., resources (e.g., resource IDs) completed previous to current time instance, or resources (e.g., resource IDs) associated with the UE (e.g., reader ID).

The monitoring occasions may be the occasions that may occur in the future, such as the occasions occurring after the current time instance, or the resources (resource IDs) scheduled after completion of the current session.

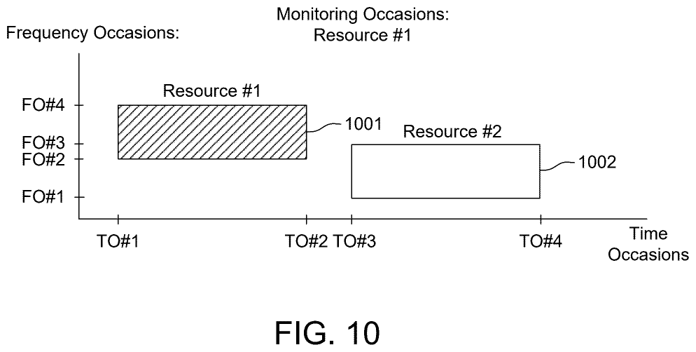

FIG. 10 illustrates the monitoring occasion relationship with a resource index.

The UE may receive an indication for monitoring occasion as resource #1 1001. Likewise, in another example, the UE may receive a time occasion indication (e.g., between TO #1 and TO #2) and or frequency occasion indication (e.g., between FO #2 and FO #4) for monitoring occasions. For resource #2 1002, the UE may receive time occasion indication (e.g., between TO #3 and TO #4) and frequency occasion indication (e.g., between FO #1 and FO #3).

The UE may be configured to determine the set of monitoring occasions based on the number of resources and/or resource IDs and/or occasions where the UE performed random-access procedure; the resource IDs, occasions (e.g., time occasions, frequency occasions) where the UE performed random-access procedure; or an indication from the network (e.g., configuration to monitor the occasions).

The UE may determine the event of overload if the number of devices successfully accessed during random access procedure is above a (pre) configured threshold. The UE may measure the ratio of number of successfully accessed devices to the number of occasions (e.g., total number of occasions, or number of monitoring occasions, etc.), and may determine the overload event if the ratio is above a (pre) configured threshold.

For example, in a monitoring occasion with total number of accessed devices N and if the total number of occasions as M, the UE may determine an overload if either N is above a (pre) configured threshold, or N/M is above a (pre) configured threshold.

The UE may determine the event of overload based on the number of collisions while receiving between the messages transmitted by the devices. The UE may determine an occasion where the UE may receive the random-access messages (e.g., random IDs, device IDs, MSG1, MSG3) from the devices but unsuccessfully attempts to decode the messages as a collision occasion.

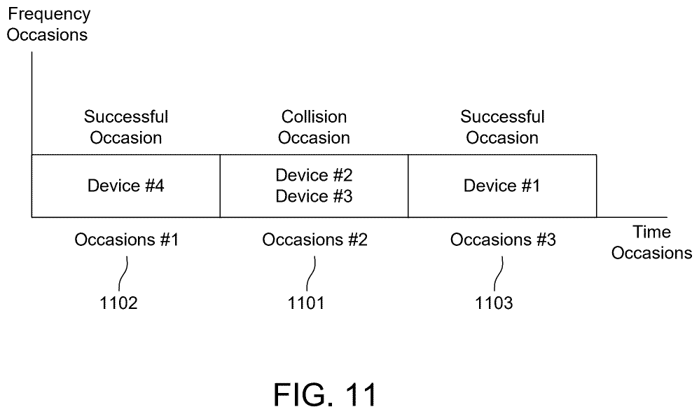

FIG. 11 illustrates an example of collision occasions and successful occasions.

For instance, as illustrated in FIG. 11, the UE may receive more than one device IDs in an occasion (e.g., occasion #2 1101) and due to interference between the message, fail to identify the device IDs or random IDs from the devices. The UE may determine the occasion #2 as a collision occasion 1101. In contrast, the UE may receive and/or decode one or more occasions (e.g., Occasion #1 1102 and Occasion #3 1103) and access the devices. The occasions may be identified as successful occasions.

The UE may be configured to perform measurements (e.g., reference signal received power (RSRP), received signal strength indicator (RSSI), signal to noise interference ratio (SINR), reference signal received quality (RSRQ) etc.) during the occasions.

The RSRP measurements for an occasion may be defined as the linear average over the power contributions (e.g., in watts, dBm.) of the time and/or frequency components (e.g., occasions, symbols, slots, frames, subframes, REs, RBs) associated with the occasions that carry the signals (e.g., AIoT D2R signals and/or messages).

The SINR measurements for an occasion may be defined as the linear average over the power contribution (in watts, dBm) of the time and/or frequency components (e.g., occasions, symbols, slots, frames, subframes, REs, RBs) associated with the occasions that carry the signals (e.g., AIoT D2R signals and/or messages) divided by the linear average of the noise and interference power contribution (in watts, dBm).

In another example, RSSI measurements for an occasion may be defined as the linear average of the total received power (in dBm, watts) observed only in the time and/or frequency components (e.g., occasions, symbols, slots, frames, subframes, REs, RBs) from all sources, including co-channel serving and non-serving readers, adjacent channel interference, thermal noise etc. associated with the occasions that carry the signals (e.g., AIoT D2R signals and/or messages).

In another example, RSRQ may be defined as the ratio of RSRP to RSSI, over the same time and/or frequency occasions shall be made over the same set of resource blocks.

The UE may determine the occasion as a collision occasion if the power measurements (e.g., RSSI, RSRP) for an occasion is above a (pre) configured threshold, or if the interference and/or quality measurements (e.g., SINR, RSRQ) for an occasion is below a (pre) configured threshold, or if the UE does not decode the device IDs in the occasion.

The UE may determine the occasion as an idle occasion if at least one or a combinations of the above conditions are false, e.g., the power measurements (e.g., RSSI, RSRP) for an occasion is below a (pre) configured threshold, or the interference and/or quality measurements (e.g., SINR, RSRQ etc.) for an occasion is above a (pre) configured threshold, or the UE does not decode the device IDs in the occasion.

The determination may be done in an occasion determined as the monitoring occasions.

The UE may determine the collision thresholds (e.g. measurement threshold) based on at least one of the following reference measurements:

The (e.g., average) measurement (e.g., RSRP, SINR, RSSI, RSRQ) for an occasion where the UE successfully accesses a device; the (e.g., average) measurement (e.g., RSRP, SINR, RSSI, RSRQ) for an occasion where the does not receive any messages from the devices; or the (e.g., average) measurement (e.g., RSRP, SINR, RSSI, RSRQ) for an occasion where the UE does not schedule any messages from the devices. The network may configure the measurements.

The reference measurements and/or the determination of the number of collision occasions may be performed over the set of monitoring occasions.

In another solution, the UE may be configured or may determine to dedicate a random-access procedure (e.g., resource) for only a group of devices. The UE may broadcast a random-access configuration indication where the configuration may additionally comprise conditions where only the devices fulfilling one or a combination of the indicated conditions may respond.

The UE may transmit to the devices at least one of the following: Resource IDs; time and/or frequency resources; response criteria such as number of unsuccessful attempts threshold. For example, the UE indicate only the devices to respond if the number of unsuccessful access attempts made by them is above the indicated threshold.

For example, the UE may indicate the devices to only respond to the random-access session if they have collided at least N times in the time and/or frequency occasions of a resource (e.g., resource ID).

For example, the UE may indicate the devices to only respond to the random-access session if they have collided at least N times in the second frequency occasion in the current resource (e.g., resource ID).

The UE may determine an overload event based on at least one of the following conditions:
The UE may determine an overload event occurred if the number of collision occasions (e.g., time, frequency occasions) is above a (pre) configured threshold, where the determination may be performed based on measurements, message (e.g., device ID, random ID, etc.) reception and/or decoding, etc. (e.g. in the monitoring occasions).
The UE may determine an overload event occurred if the number of previous unsuccessful attempts reported by the devices is above a (pre) configured threshold, e.g., the number may be average over the number of reporting devices, e.g., over a resource ID.
The UE may determine an overload event occurred if the number of devices who are successfully accessed during the sessions dedicated to the device groups with number of unsuccessful attempts above a (pre) configured threshold. The determination may be performed based on the message (e.g., device ID, random ID) reception and/or decoding within an indicated time and/or frequency occasions.
The UE may determine an overload event based on determination of at least one of the mentioned events within the monitoring occasions.

Number of occasions: The UE may determine an overload event if the number of occasions (e.g., associated with a resource IDs) is below a (pre) configured threshold. For example, the number of occasions may either be the number of time occasions, frequency occasions or the sum of the time and/or frequency occasions.

Target number of devices threshold: The UE may determine an overload event based on the number of devices accessed, and target number of devices to access threshold. The UE may determine an overload event if the number of accessed devices compared to the target number of devices to access is below a (pre) configured threshold. The UE may determine an overload event if the total number of devices to access (e.g., difference between target number of devices to access and the total number of devices accessed (e.g., in a resource, resource ID) is above a (pre) configured threshold.

Reporting of overload event.

The UE may be configured to report an overload event when an overload occurs.

The UE may be configured to report an overload event when the target number of devices to access is above a (pre) configured threshold.

The UE may be configured to report an overload event when the number of collision occasions (e.g., during the monitoring occasions) is above a (pre) configured threshold.

The UE may be configured to report an overload event when the number of (e.g., consecutive) collision time occasions is above a (pre) configured threshold.

The UE may be configured to report an overload event when the number of (e.g., consecutive) collision occasions associated with the same frequency occasion index (e.g., RE, RB) is above a (pre) configured threshold.

The UE may be configured to report an overload event when the number of readers in the vicinity or proximity (e.g., within a (pre) configured distance from the UE location) is above a (pre) configured threshold.

The UE may be configured to include the determined monitoring occasions, e.g., resource IDs, time occasions (e.g., occasion index, symbol index, slot index, frame index, sub-frame index), frequency occasions (e.g., occasion index, RE index, RB index) in the overload report.

The UE may be configured to include the number of devices accessed (e.g., in the monitoring occasions) in the overload report.

The UE may be configured to include the ratio of number of successfully accessed devices to the number of occasions (e.g., total number of occasions, or number of occasions monitored) in the overload report.

The UE may be configured to include the number of determined collision occasions in the overload report.

The UE may be configured to include the number of collision occasions (e.g., average, median, etc.) reported by the devices (e.g., within the monitoring occasions) in the overload report.

The UE may be configured to include the collision occasion indices (e.g., time occasions, frequency occasions) in the overload report.

The UE may be configured to include in the overload report: (e.g., average, median) measurements (e.g., RSRP, SINR, RSSI, RSRQ) of the occasions, where the occasions (e.g., monitoring occasions) may be at least one of the: Occasions determined as collision occasions, occasions where the UE successfully accesses a device, occasions where the UE does not receive anything, or occasions where the UE does not schedule any messages from the devices.

The UE may be configured to include the number of devices successfully accessed during the random-access sessions dedicated to the colliding devices in the overload report.

The UE may be configured to include the device IDs and/or random IDs of the successfully accessed devices in the overload report.

The UE may be configured to include the uncertainty associated with the measurements in the overload report.

The UE may be configured to include the timestamp (e.g., in terms of symbol index, slot index, frame index, sub-frame index, milliseconds, occasion index) associated with the measurements, determination of collision.

The UE may receive an indication to terminate the random-access procedure.

In one example, the UE (e.g., reader) may receive a configuration (time, frequency resources) for random access with a resource ID, number of access occasions (e.g., Q value) and various thresholds. The UE may initiate an access procedure by broadcasting the resource ID and number of access occasions. The UE may receive responses from one or more devices in the indicated occasions, where the response comprises at least the number of previous access attempts during the access procedure. The UE may determine whether or not there is an access overload event, wherein the determination may be based on at least one number of accessed devices (e.g., average per occasion) being above a threshold; or number of collision occasions being above the threshold, where a collision is determined to occur based on number of occasions where the UE receives but fails to decode a device ID, or based on the number of previous access attempts indicated by the accessed devices. The UE may report the overload event to the network. The UE may receive a random access termination indication from the network.

Procedures to reduce device overload

The UE may be configured by the network to reduce the overload in the random-access procedure. The configuration may be sent after the overload event report. In this case, the UE may receive a configuration comprising the time and/or frequency resources for the second random access procedure. In one example, different configuration may be associated with a resource ID.

Upon reporting overload to the network, the network may send second assistance information o t UE.

The second assistance information may include a resource ID.

The UE may be configured by the network with one or more resource IDs from the network. In one example, each resource ID may be associated with one or more set of configuration and/or one or more assistance information (e.g., assistance information IDs, first assistance information, second assistance information).

The second assistance information may include the relationship between the resource IDs and/or reader IDs.

The relationship may be a hierarchical relationship. For example, a set of second resource IDs (e.g., corresponding to sub-sessions) may be one associated with the first resource ID (e.g., corresponding to a session) where the second resource IDs may be a child node of the first resource IDs in a tree representation. Similarly, the set of first resource IDs may be associated (and a child node) of a reader ID. The UE may indicate the relationship (e.g., associated with at least one or more of the resource IDs) (e.g., activated resource IDs, e.g., sessions) and/or the reader IDs to the devices (e.g., in the random-access indication).

The second assistance information may include reader IDs, and associated information (e.g., reader location): The UE may receive one or more reader IDs (e.g., UE IDs, TRP IDs) from the network. In one example, one or more reader IDs may be associated one or more resource IDs.

The second assistance information may include the set of reader IDs that may assist the UE to reduce the random-access device overload.

The readers may also be associated with at least one or more aspects, configuration, assistance information etc. of the resource IDs. The association of a reader ID with the resource IDs may indicate the resources and/or assistance information associated with the reader IDs.

For example, a reader ID associated with an access window (e.g., access window ID) may indicate the time window activated by the indicated reader ID. The UE may receive the information associated with reader IDs including at least one the reader location.

The second assistance information may include reader transmission power (e.g., in watts, dBm).

The UE may be configured with one or more sets of transmission power from the network (e.g., for random access procedure). The transmission power, in one example, may be based on the (e.g., reported) UE capability. The UE may receive the transmission power as at least one of the following: Minimum and/or maximum transmission power (e.g., in terms of dBm, watts); set of transmission powers (e.g., discrete set) (e.g., in terms of dBm, watts); or transmission power granularity, (e.g., in terms of dBm, watts).

For example, the UE may receive a set of transmission powers e.g., [X1 dBm, X2 dBm, X3 dBm] and the UE may determine which transmission power to use. The UE may be configured with a minimum (e.g., Y1 dBm) and maximum power (e.g., Y2 dBm) and a granularity (e.g., G dBm). The UE may then determine any of the transmission power from the set [Y1 dBm, Y1 dBm+G, Y1 dBm+2G, . . . , Y2 dBm].

The second assistance information may include transmission beam information.

The transmission beam information may include uplink reference signal (UL RS) ID, beam IDs (e.g., one of the (pre) configured UL RS may be any uplink reference signal (e.g., SRS, SRSp) configured by the network for the UE to transmit the random-access message (e.g., configuration, messages). The transmission beam information may include transmission configuration indicator (TCI)-State ID, TCI-UL-State ID: The UE may receive the TCI state and/or TCI-UL-State ID indicating a relationship with the ID and one or more of the reference signals (e.g., DL RS, UL RS) beams or resources. The UE may determine to activate the beams associated with the TCI-State and/or TCI-UL-State ID.

The transmission beam information may include reference UL RS and/or DL RS. The UE may receive a reference UL RS which determine the transmission beam based on the spatial relationship associated with the reference (e.g., QCL information, spatial relationship information). The UE may receive a reference DL RS and may determine the transmission beam based on the spatial association one or more transmission beams (e.g., QCL information, spatial relationship information).

The transmission beam information may include angle of departure (AoD), beam direction. The UE may receive an indication of the beam direction in terms of reference angles (e.g., AoD) and the UE may determine the transmission beam based on it.

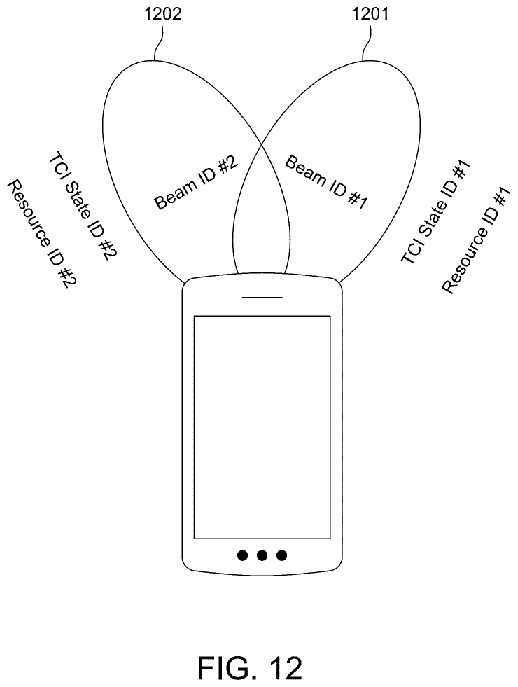

FIG. 12 illustrates the association between beam IDs and TCI-State IDs.

The beams may be associated with resource IDs and activation of a resource ID may activate an associated beam. An example is illustrated in FIG. 12, the UE may receive an indication to transmit a beam ID #1 1201 by transmitting an indication to activate TCI-State #1. In another example, activation of resource #1 may activate the associated beam ID #1 1201 and resource #2 may activate the associated beam ID #2 1202.

The second assistance information may include targeted device groups configured for each resource ID. One or more device group indications may be associated with a resource ID.

The UE may be configured with the one or more device groups. The device group may be an indication from the network for the UE to only access and/or inventory the devices associated with a certain group. The device group may be indicated by the UE to the devices during the random-access procedure to ensure that only the devices associated with a certain group respond. The device group may be an indication from the UE to request for one or more information from the devices during the random-access procedure. The device group may be an indication to the UE to only report the devices associated with a certain group.

A group may be defined by one or more set of conditions and/or events and/or (e.g., (pre) configured) properties (e.g., device properties) that may be associated with the measurements, information generated or associated with a device (e.g., AIoT device). The UE may be configured or may determine to indicate a group indication to the devices during the random-access procedure including at least one or a combination of the following: Device type (e.g., device 1, device 2a, device 2b, energy harvesting device, devices harvesting energy from RF source, backscattering device, active device, etc. or any other device types that an AIoT device might be); device energy level (e.g., in terms of Joules, any other transmission energy units, etc., minimum energy level, maximum energy level, energy harvesting rate); device battery capacity (e.g., in terms of Joules, any other transmission energy units); device mobility (e.g., mobile, static, velocity of the device, e.g., in terms of meters per seconds); devices that experience similar duration since last successful random-access and/or inventory occasion (e.g., in terms of number of occasions).

The UE may be indicated with threshold values for one or more of the above indicated conditions to indicate to the devices. For example, the UE may be configured with thresholds for device energy levels, velocity, etc. based on which the devices may respond.

The second assistance information may include targeted device response rate.

The UE may be configured with one or more response rates (e.g., in percentage, from 0 to 1, etc.) indicating the number of devices, rate of devices and/or percentage of devices who may determine to transmit in the (e.g., associated) resource ID.

The UE may receive associations between the resource IDs with at least one or more of the first and/or second assistance information parameters. In one example, each resource IDs may be associated with one or more of the parameters associated with the first assistance information ore the second assistance information A resource ID may be associated with an assistance information ID. A resource ID may be associated with random access time windows (e.g., access window IDs). A resource ID may be associated with other random-access parameters, such as, number of time occasions (e.g., Q-value), number of frequency occasions, time occasion type (e.g., periodic, semi-persistent, aperiodic), trigger conditions and/or associated with the time occasion type (e.g., trigger conditions to transmit a time occasion indication to the devices for semi-persistent, aperiodic type). A resource ID may be associated with an R2D modulation (e.g., ASK, OOK) and/or encoding methods (e.g., Manchester encoding) and/or a D2R modulation (e.g., ASK, OOK) and/or encoding methods (e.g., FMO encoding, Miller encoding). A resource ID may be associated with a UE transmission timing and/or a device transmission timing. A resource ID may be associated with one or more configured thresholds.

In one example, each resource IDs may be associated with at least one of the parameters associated with the second assistance information, such as, assistance information IDs, reader IDs and associated information (e.g., reader locations), transmission powers, transmission beams, device groups, response rates.

### Random-Access Procedures for Reduce Device Overload

The UE may initiate the random-access procedure, indicating at least one of the resources and/or assistance information (e.g., first assistance information, second assistance information) to the devices. The UE may determine to reduce the overload.

In one example, the UE may determine to reduce the overload via activation and/or deactivation of resources. The UE may be (pre) configured with one or more sets of resources, e.g., associated with resource IDs. The UE may receive an indication (e.g., higher layer (RRC, LPP) or lower layer (DCI, MAC-CE)) that may activate and/or deactivate one or more resources. The activation and deactivation may initiate use of a set of resources and/or assistance information for random-access.

The UE may receive an ID (e.g., resource ID, time window ID, assistance information ID, etc.) for activation and deactivation. In one example, activation of a first ID may activate a second ID, if they are associated with each other. In another example, activation of one ID may deactivate a second ID (e.g., if they are of a similar type). For instance, activation of one resource ID may activate the associated time window ID. Activation of a resource ID may deactivate another resource ID and/or other associated configuration.

The activation or deactivation of the resource IDs may be based on the (e.g., configured) relationship (e.g., hierarchical). For example, an activation of a first resource ID (e.g., session ID) may activate one or more resource IDs (e.g., the children nodes in the hierarchy, e.g., sub-session IDs). For example, activation of a first resource ID (e.g., session ID) may deactivate a second resource ID (e.g., its neighboring nodes, e.g., other session IDs)

The UE may be configured to perform activation and/or deactivation of the configuration by the network based on at least one of the following:
In another example, the UE may determine to reduce the overload via an indication of multiple sets of resources. The UE may be configured or may determine to reduce the overload or the number of devices attempting to access the UE by indicating and transmitting more than one sets of resources to the devices.
For instance, the UE may be configured with more than one sets of resource configuration. In one example, each of them may be associated with a (e.g., orthogonal) set of time and frequency resources. The UE may indicate at least one of the following to the devices for random access in the random-access configuration: Resource IDs, time resources (e.g., associated with the configuration IDs, session IDs, sub-session IDs), frequency resources (e.g., associated with the configuration IDs, session IDs, sub-session IDs), Assistance information IDs.
In one example, the UE may receive the configuration from the network for random access and may determine to split the resources into multiple resources. The UE may be configured to determine the number and the resources to allocate to each resource IDs for the random-access procedure based on the total allocated time resources (e.g., time duration); or the total allocated frequency resources (e.g., bandwidth); or the total allocated resources and/or occasions (e.g., in the previously activated resource IDs).

The UE may be configured to determine the number and the resources to allocate to each resource IDs for the random-access procedure based on the number of collisions (e.g., in the monitoring occasions, previously activated resource IDs); or the (e.g., average, median) measurements (e.g., RSRP, SINR, RSSI, RSRQ) (e.g., in the monitoring occasions, previously activated resource IDs).

The UE may be configured to determine the number and the resources to allocate to each resource IDs for the random-access procedure based on the configured target number of devices; or the number of devices accessed (e.g., in the monitoring occasions, previously activated resource IDs).

The UE may compare above parameters with a threshold to decide the resource to use.

When determining the resources, and/or assistance information, for the second resource ID, the UE may use the first assistance information associated with the first resource ID, the history of outcome of previous accesses, the parameters used in other resources, the outcome of the accesses in other resources, or the allocated resources of a first resource IDs.

The UE may be configured to transmit (e.g., during random access configuration, occasion indications, etc.) one or more resource IDs and/or the number of determined or configured resource IDs and/or one or more associated parameters (e.g., time, frequency occasions associated with the IDs). The UE may transmit the number of configuration, sessions and/or sub-sessions. For instance, the UE may send the resource IDs (e.g., ID #1, ID #2), the parameter(s) associated with each resource ID (e.g., ID #1: Q=10, ID #2: Q=15) and/or the number of resource IDs (e.g., 2). Parameter of each resource (time t1, time t2) where 1st ID is sent in time t1, 2nd in time T2.

This may be an indication for the devices to select at least one of the resource IDs. For instance, if ID(s) are sent by the UE, the device may select, e.g., ID #1. If number of IDs are sent, the device may select, e.g., 2nd ID.

In another example, the UE may determine to reduce the overload via UE indication in a certain coverage area. The UE may be configured or determine reduce the overload by reducing the coverage area where the random-access message may be indicated.

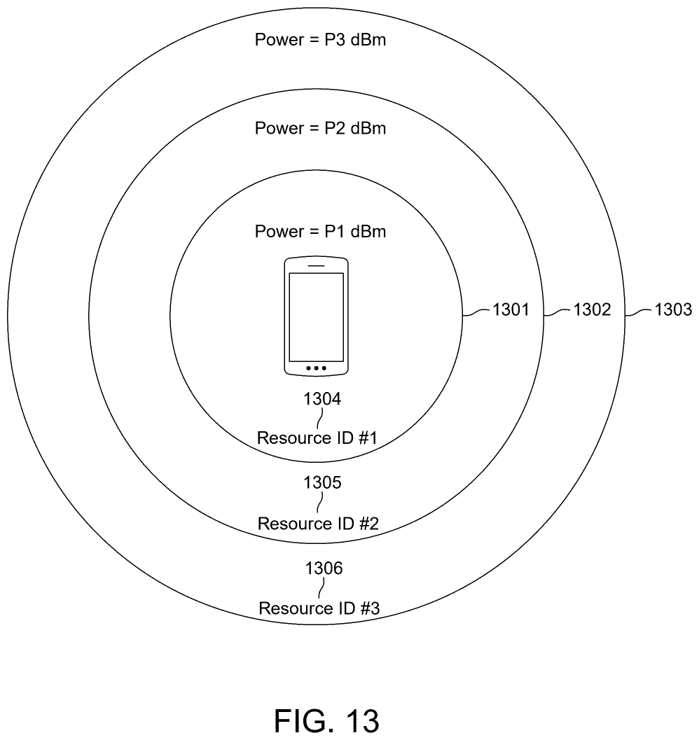

The UE may determine to reduce the overload via adjusting transmission Power:
FIG. 13 illustrates an example of splitting of coverage area by adjusting transmission power.
The UE may change the coverage area based on transmission power, e.g., as illustrated in FIG. 13. In this example, the UE use power P1 1301, P2 1302, or P3 1303 (dBm) to change the coverage area (e.g., indicated by the circle around the UE). The UE may decrease the power (e.g., use P1) for a limited coverage and hence the limited number of devices attempting to access the UE (e.g., compared to power P3). In one example, each of the power may be associated with different resource IDs: resource ID #1 1304 for power P1 1301, resource ID #2 1305 for power P2 1302, and resource ID #3 1306 for power P3 1303.
The UE may determine to transmit (e.g., random access configuration, occasion indications, etc.) with a certain transmission power based on the transmission power associated with other (e.g., previous, deactivated) resource IDs.
The UE may determine to transmit with a certain transmission power based on the configured maximum and minimum transmission power.
The UE may determine to transmit with a certain transmission power based on the determined number of resource IDs.
The UE may determine to transmit with a certain transmission power based on the number of resources (e.g., time and/or frequency), configuration (e.g., number of occasions) associated with each resource.
The UE may determine to transmit with a certain transmission power based on the number of accessed devices in the (e.g., previous, deactivated) resource IDs.
The UE may determine to transmit with a certain transmission power based on the number of collisions in the other (e.g., previous, deactivated) resource IDs.
The UE may determine to transmit with a certain transmission power based on the (e.g., average, median) measurements (e.g., RSRP, SINR, RSSI, RSRQ) (e.g., previous, deactivated) resource IDs.
The UE may determine to transmit with a certain transmission power based on the (e.g., average, median) reference measurements.
The UE may determine to transmit with a certain transmission power based on the reader location (e.g., the distance between the UE and other readers, the UE zone ID, geographical location, etc.).
The UE may determine to transmit with a certain transmission power based on the number of readers in proximity of the UE.
The UE may determine to transmit with a certain transmission power based on configuration from the network.
The UE may determine to use one transmission power if the above factors are below a (pre) configured threshold, and another otherwise. The UE may determine the transmission power as one from the set of transmission powers configured by the network and/or based on UE capability.
The UE may be configured, or may determine to increase the transmission power in each subsequent sub-session (e.g., ranging from minimum to maximum). The UE may increase the power linearly, such as a fixed power ramping up, or nonlinearly (e.g., based on function of factors the power may depend, as discussed earlier). Changing the transmission power in each configuration, sessions or sub-sessions proportionally increases the coverage area where the devices may receive the random-access indications in. In one example, each resource ID may be associated with a transmission power.

In another example, the UE may determine to reduce the overload based on transmission beam.

The UE may change the coverage area and hence the number of devices attempting to access the UE based on transmission beam. The UE may determine to transmit (e.g., random access configuration, occasion indications) with a certain transmission beam (e.g., beam direction, beam width) configured by network based on the transmission beam associated with other (e.g., previous, deactivated) resource IDs.

The UE may determine to transmit with a certain transmission beam based on the determined number of resource IDs.

The UE may determine to transmit with a certain transmission beam based on the number of accessed devices in the (e.g., previous, deactivated) resource IDs.

The UE may determine to transmit with a certain transmission beam based on the number of collisions in the other (e.g., previous, deactivated) resource IDs.

The UE may determine to transmit with a certain transmission beam based on the (e.g., average, median) measurements (e.g., RSRP, SINR, RSSI, RSRQ) (e.g., previous, deactivated) resource IDs.

The UE may determine to transmit with a certain transmission beam based on the (e.g., average, median) reference measurements.

The UE may determine to transmit with a certain transmission beam based on the reader location (e.g., the distance between the UE and the readers).

The UE may determine to transmit with a certain transmission beam based on the number of readers in the vicinity of the UE.

The UE may determine to transmit with a certain transmission beam based on the configuration from the network.

The UE may determine to use one transmission beam if the above factors are below a (pre) configured threshold. The UE may be configured or may determine to perform beam sweeping (e.g., use a neighboring beam in the subsequent resource IDs).

The UE may be configured with or may determine the order of beam transmission (e.g., sequence of beam transmission).

The UE may either determine to transmit in the same coverage area (e.g., with same power and/or transmission beam) as other resource IDs and/or reader IDs based on the number of collisions in other (e.g., previous, deactivated) resource IDs (as compared to a (pre) configured threshold).

The UE may either determine to transmit in the same coverage area as other resource IDs and/or reader IDs based on the number of idle occasions in other (e.g., previous, deactivated) resource IDs being above a (pre) configured threshold.

The UE may either determine to transmit in the same coverage area as other resource IDs and/or reader IDs based on the number of accessed devices in other (e.g., previous, deactivated, etc.) resource IDs being above a (pre) configured threshold.

The UE may either determine to transmit in the same coverage area as other resource IDs and/or reader IDs based on the target number of devices to access is above a (pre) configured threshold

The UE may either determine to transmit in the same coverage area as other resource IDs and/or reader IDs based on an indication from the network.

These conditions may determine that there may be more devices in the coverage area to access.

In another example, the UE may determine to reduce the overload via an UE indication for a subset or group of devices to respond. The UE may indicate only a subset of devices (e.g., the devices who receive the resource and/or random-access indication and/or occasion indication transmitted by the UE).

The UE may indicate for only a subset of devices to respond based on response rate. The UE may be configured to transmit (e.g., during random access configurations, occasion indications) a response rate (e.g., associated with a resource ID) to the devices in the paging message. The response rate may indicate only a fraction of the devices who received the UE transmission to respond (e.g., transmit random IDs and/or device IDs). The UE may be configured to determine the response rate to transmit based on the response rate in other (e.g., previous, deactivated) resource IDs.

The UE may be configured to determine the response rate to transmit based on the number of accessed devices in other resource IDs.

The UE may be configured to determine the response rate to transmit based on the number of collisions in other resource IDs.

The UE may be configured to determine the response rate to transmit based on the number of idle occasions in other resource IDs.

The UE may be configured to determine the response rate to transmit based on the target number of devices to access.

The UE may be configured to determine the response rate to transmit based on an indication from the network.

The UE may determine one response rate if the above factors are above a (pre) configured threshold, and another otherwise.

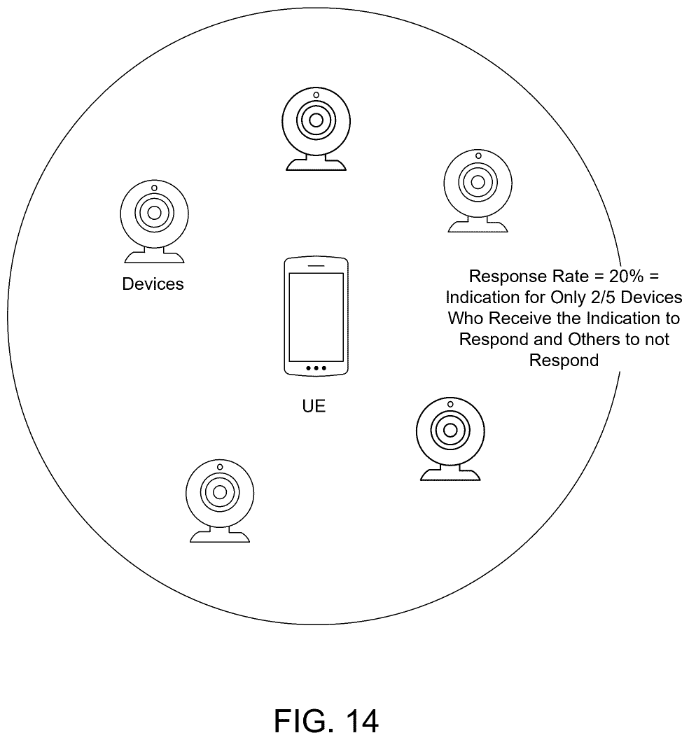

FIG. 14 illustrates the response rate indication in the random access message. With a response rate of 20%, approximately 2 devices out of 5 will respond.

The UE may be configured to transmit (e.g., during random access configuration, occasion indications, etc.) a device group indication (e.g., associated with a resource IDs). The device group indication may indicate to the devices to respond only if it satisfies one or more combinations of the requirements and/or trigger events and/or conditions.

In another example, the UE may determine to reduce the overload broadcasting different reader IDs. The UE may indicate to the devices one or more reader IDs (e.g., UE IDs, TRP IDs, etc.) that may initiate the random-access or inventory procedure. The UE may transmit at least one of the following to the devices: Reader IDs, number of readers, resource IDs associated with the random access procedure, configuration, assistance information (e.g., IDs) (e.g., associated with resource IDs), or location of reader IDs.

The UE may indicate the reader IDs to the devices so that the devices may select one or more readers from the indicated set. In one example, more than one readers may be associated with the same resource (e.g., IDs), configuration (e.g., IDs), and/or assistance information (e.g., IDs).

In another example, the UE may determine to reduce the overload via an UE indication for a subset of devices to not respond.

The UE may indicate a subset of devices to not respond to the random-access indications, and/or occasion indications (e.g., to reduce the device overload).

The UE may request the devices to not respond if the time duration since the devices were successfully accessed is below a (pre) configured threshold. The UE may transmit the (pre) configured threshold duration to the devices.

The UE may request the devices to not respond if they have been previously successfully accessed by the same reader (e.g. UE, reader IDs).

The UE may request the devices to not respond if they have been previously successfully accessed with the same resource IDs.

The UE may request the devices to not respond if the inventory flag is on.

The UE may request the successfully accessed devices (e.g., for a resource IDs, reader IDs etc.) to turn on the inventory flag. The UE may indicate to turn off the inventory flag and/or respond to the device if:
The UE indicates the termination of random-access procedure associated a reader IDs, resource IDs. Only the devices who were successfully accessed with the same reader IDs, resource IDs may turn off the inventory flag.
The UE indicates all the devices to turn off the inventory flag.
The UE indicates a time duration from a reference time after which the devices may turn off the inventory flag, where the reference time may be at least one of the following: The time instance when the device is successfully accessed; or the time instance when the UE indicates the termination of a random-access procedure (e.g., associated with a configuration ID, session ID and/or sub-session ID).

In another example, the UE may determine to reduce the overload via a UE indication of new configuration parameters. The UE may be configured or may indicate configuration parameters (e.g., number of time and/or frequency occasions, etc.) to the devices. The UE may determine the one or more parameters for a resource based on at least one of the following conditions: The configured time and/or frequency resources; the configuration parameter in other (e.g., previous, deactivated) resource IDs; the target number of devices to access; the number of collisions in the other (e.g., previous, deactivated) resource IDs; the number of successfully accessed devices other (e.g., previous, deactivated) resource IDs; or the number of idle occasions in other (e.g., previous, deactivated) resource IDs.

The UE may determine one set of resources and/or associated configuration parameters if at least one or a combination of above factors are above a (pre) configured threshold, and another set otherwise.

For example, the UE may determine to transmit an increased number of occasions if the number of collisions if the other (e.g. previous) resources is above a (pre) configured threshold. The UE may determine to deactivate one or more frequency occasions (e.g., REs, RBs, etc.) in a resource based on the number of collisions, measurements, number of accessed devices associated with the frequency occasions in other (e.g., previous, deactivated, etc.) resource IDs.

In another example, the UE may determine to reduce the overload via UE indication random access statistics and/or measurements. The UE may be configured by the network or may determine to indicate random access statistics and/or measurements to the devices (e.g., associated with other (e.g., previous, deactivated, etc.) resource IDs). The UE may indicate at least one of the following to the devices: The number of accessed devices; number of collisions; number of idle occasions; the (e.g., average, median, variance) of measurements (e.g., RSRP, SINR, RSSI, RSRQ); or the (e.g., average, median, variance) of reference measurements.

These measurements may indicate the devices to autonomously decide whether to respond or not the random-access indication or request based on one or more of the indicated statistics and/or measurements.

In another example, the UE may determine to reduce the overload via UE indication the devices to pause the random access. The UE may be configured or may determine to pause the random-access procedure. The UE may be configured a timer (e.g., a backoff timer) which may be triggered based on one or more combination of the following events: The number of (e.g., consecutive) collision occasions is above a (pre) configured threshold; the number of (e.g., consecutive) idle occasions is above a (pre) configured threshold; the number of accessed devices is above a (pre) configured threshold; or an indication from the network.

The UE may initiate the timer after indicating the event (e.g., pause the random access procedure) and the backoff timer to the devices.

The UE may indicate other reader IDs and/or resource IDs to the devices that the devices may choose. The UE may restart the procedure after the timer expires. The UE may indicate the restart of the session with reader ID and/or a resource ID. The IDs may be the same as the ones used before starting the timer.

UE indication of one or more combination of procedures: The UE may be configured to indicate to the devices of one or more combinations of the assistance information (e.g., for each random-access indication). For example, the UE may be configured to indicate the device group indications and transmit with a certain transmission power. For example, the UE may be configured to transmit with a certain beam with maximum transmission power. For example, the UE may be configured to combine one or more procedures per random access indication or resource ID.

A UE determines the order of resource IDs: The UE may be configured by the network to perform the procedure with more than one resources where each may be associated at least one or a combination of the: different transmission power, transmission beam, group indications, associated reader IDs, random access parameters, response rates, time window IDs.

The UE may receive an indication to activate a resource ID from the network. The UE may receive at least one of the following for activation: Resource ID, assistance information ID, access window ID, UL RS ID, TCI-State ID, or TCI-UL-State ID.

In such case, the UE may determine the order of the procedures as the order how it receives the activation and/or configuration. For example, if the UE receives a first indication to activate a Resource ID #1 and subsequently Resource ID #2, the UE may determine to activate the sessions in the same order.

The UE may determine the order based on at least one of configuration parameters. For example, the UE may determine to prioritize the resources in an ascending order with respect to transmission power (e.g., start resources first with lower transmission power).

The UE may be configured to determine the order based on the associated indication of time (e.g., time resource, time window parameters).

The UE may be configured to determine only the order of the activated resource IDs.

The UE may be configured with the order of the resources. For example, the resource IDs may be associated with the order (e.g., numerical order, such as 1,2,3) corresponding to the order how it may be activated.

The UE may be configured to indicate the determined order to the devices. For example, the UE may indicate the resource IDs in the configured or determined sequence indicating the order to the devices. The UE may indicate the time of activation (e.g., in terms of symbol index, slot index, frame index, sub-frame index, absolute time) indicating the order.

The UE may receive responses from one or more devices (e.g., based on the indication conditions, criteria, device groups, response rates) in the configured or indicated occasions for each resource.

The UE may determine to terminate a resource based on certain conditions being met.

The UE may determine to terminate a resource based on the expiry or deactivation of the access time window (e.g., associated with the reader ID, resource ID).

The UE may determine to terminate a resource based on the number of collisions (e.g., associated with the reader ID, resource ID.) being above a (pre) configured threshold.

The UE may determine to terminate a resource based on the number of idle occasions (e.g., associated with the reader ID, resource ID, etc.) being above a (pre) configured threshold.

The UE may determine to terminate a resource based on the number of accessed devices being above a (pre) configured threshold (e.g., target number of accessed devices devices).

The UE may determine to terminate a resource based on an indication from the network.

The UE may indicate the resource ID termination to the devices. In one solution, the indication may comprise an indication to stop monitoring the random-access messages (e.g., associated with the resource ID, reader ID), or turn down the inventory flag, or start a timer (e.g., to turn down the inventory flag, for next random access request monitoring and/or response).

The UE may determine to report certain access outcomes and statistics to the network.

The UE may be configured by the network to report to the network upon termination of the resource ID. In one example, the UE may report at least one of the following (e.g., associated with the resource ID): Successfully accessed IDs, number of collision occasions, number of idle occasions, measurements (e.g., RSRP, RSRQ, SINR, RSSI), number of occasions, time duration associated with the resource, time stamp (e.g., in terms of symbol index, slot index, frame index, sub-frame index, occasion index) associated with accessing device IDs, measurements, and/or activation of resource IDs. In one example, the UE may report the information (e.g., IDs, measurements, etc.) acquired since previous measurement reporting instance.

The UE may be configured by the network to terminate the random access procedure based on certain conditions being met.

The UE may be configured by the network to terminate the random access procedure when all resources have been terminated.

The UE may be configured by the network to terminate the random access procedure based on the number of collision occasions (e.g., associated with one or more resource IDs) being above a (pre) configured threshold.

The UE may be configured by the network to terminate the random access procedure based on the number of idle occasions (e.g., associated with one or more resource IDs) is above a (pre) configured threshold.

The UE may be configured by the network to terminate the random access procedure based on the number of accessed device (e.g., associated with one or more resource IDs) above a (pre) configured threshold.

The UE may be configured by the network to terminate the random access procedure based on an indication from the network, etc.

In one example, the UE may indicate to the device of procedure termination.

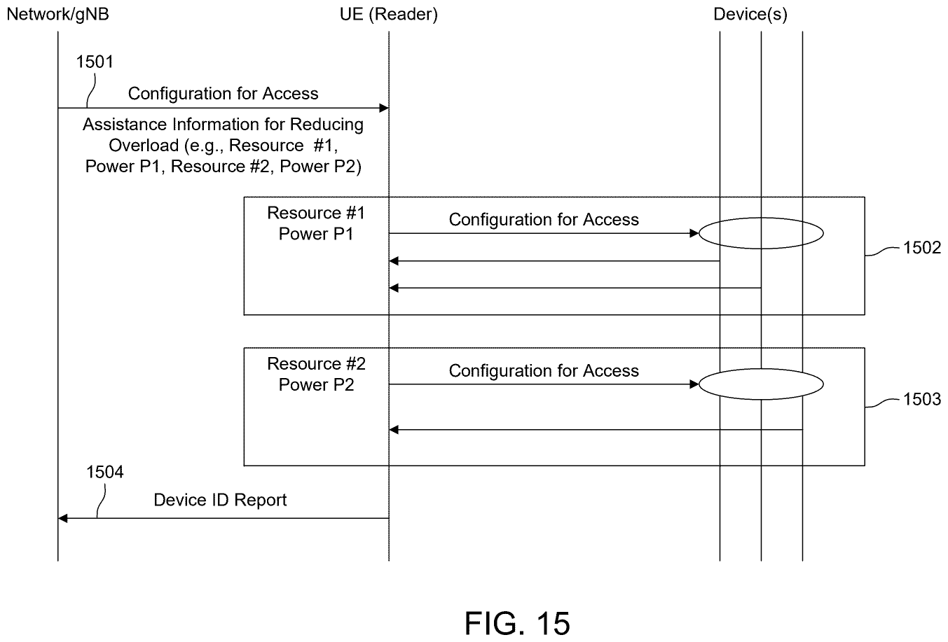

FIG. 15 illustrates an example of a call flow of the AIoT random access procedure between the network, UE and the devices.

The UE may receive, from the network, second assistance information 1501 to reduce device overload. The UE may determine the resources to use and transmit using resource #1 1502 and resource #2 1503, with different transmission powers. The UE may receive the responses from the devices, including the device IDs. The UE may report the device IDs received to the network 1504.

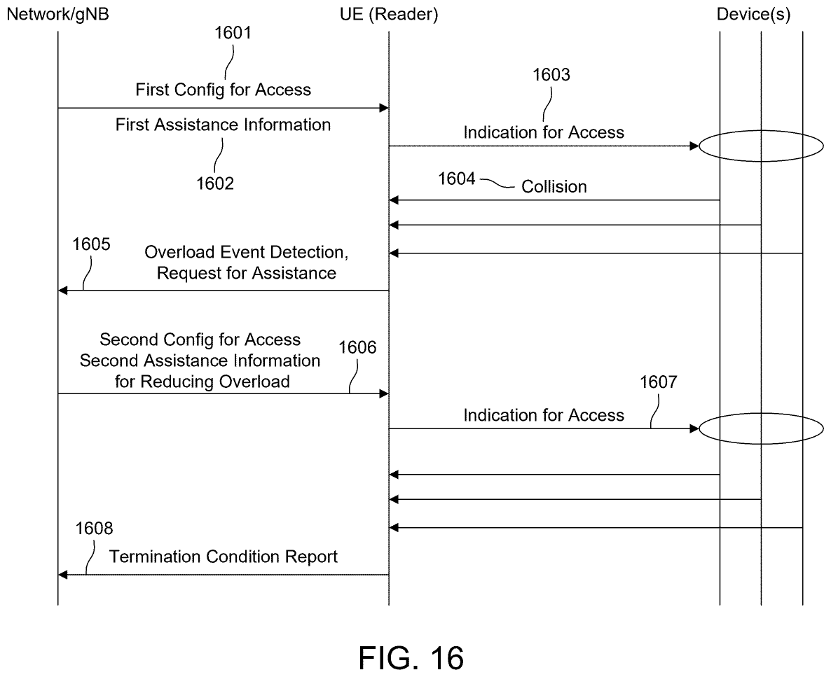

FIG. 16 illustrates an example of the dynamic load balancing procedure.

A UE (e.g., reader) may receive configuration information for random access procedure from a network 1601. The configuration information may comprise configuration for one or more physical resources, including time and frequency allocation. Each resource configuration may be identified by a resource ID. The configuration information may further comprise first assistance information 1602.

The first assistance information may include an assistance information ID, a random access time window, parameters associated with random access procedure, MCS, UE and device transmission timings, various thresholds, and information on other readers.

The UE may receive an ID associated with each set of assistance information. The assistance information IDs may be associated with one or more resource IDs.

The UE may determine a resource ID and an associated first assistance information to be used for the access. The UE may initiate a random access for the determined resource ID by broadcasting the resource ID to the devices. The UE may include some or all information from the first assistance information in the broadcast message. The UE may receive responses from the devices and determine if a collision occasion occurred 1604.

The UE may terminate the access procedure for that given resource ID if one or more of the following events occurred: the number of (consecutive) collision occasions is above a threshold, the number of devices accessing the resource is above the maximum number configured, or all access occasions have been utilized.

Upon terminating the access procedure, the UE may indicate the termination to the devices. The UE may initiate an access procedure for the next resource ID. When the access procedure is terminated for all resource IDs configured in the UE, the UE may report, to the network, the device ID of the devices that succeeded the access attempt.

In the event of an overload detection, the UE may indicate the overload to the network 1605, requesting second assistance information. The UE may receive the second assistance information from the network 1606. The second assistance information may include a resource ID, a reader transmit power, a reader transmit beam ID, a transmission configuration indicator (TCI) state, reference signals, and a device group. The device group may be associated with one or more of: a device type, a device energy level threshold, a device battery capacity, a mobility condition of the device, or the time since last successful access attempt.

The second assistance information may enable the UE to control the number of devices accessing at the same, and thus minimize the chances of overload occasions in future attempts. The UE may use the newly provided second assistance information in future access initiations.

The UE may determine a resource ID and an associated second assistance information ID to be used for the access. When initiating an access 1607, the UE may send one or more of the following information to the device: Reader ID (e.g., UE ID), resource IDs, association between the resource ID and the assistance information ID, the order or resource IDs, time resources, frequency resources, access time window configuration (e.g., access window ID, start time, stop time, etc.), modulation and/or encoding for R2D and D2R messages, number of time occasions (e.g., Q-value), number of frequency occasions, time slot indication (e.g., indicated by the UE, determined by the device), R2D and/or D2R transmission timings, transmission power, transmission beam, Other reader IDs (e.g., UE IDs, TRP IDs, associated configuration ID, session ID, sub-session ID), response rates, device group indication, number of collisions, or number of target devices, etc.

Upon terminating the access procedure, the UE may indicate the termination to the devices. The UE may initiate an access procedure for the next resource ID. When the access procedure is terminated for all resource IDs configured in the UE, the UE may report, to the network, the device ID of the devices that succeeded the access attempt.

When all resource IDs have been terminated, the UE may report to the network the successfully accessed device IDs 1608.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed by a wireless transmit and receive unit (WTRU), the method comprising:
receiving, from a network, first configuration information comprising first resource information, wherein the first resource information includes an indication of time and frequency resources to be used in an ambient Internet of things (AIoT) access procedure;
receiving, from the network, first assistance information comprising first assistance parameters associated with the first resource;
sending the first AIoT message using the first resource and the first assistance parameters;
monitoring access occasions and determining that an overload occasion occurred;
sending, to the network, an overload indication;
receiving, from the network, second assistance information comprising second assistance parameters; and
sending the second AIoT message using the first resource and the second assistance parameters.

2. The method of claim 1, wherein the first assistance parameters include one or more of: a maximum UE transmit power, a number of frequency occasions, a number of time occasions, or a time occasion type.

3. The method of claim 2, wherein the time occasion type comprises periodic type, aperiodic type or semi-persistent type.

4. The method of claim 1, wherein the first assistance parameters comprise a random access time window including one or more of: a start time, an end time, a periodicity, or a time offset.

5. The method of claim 1, wherein the second assistance parameters comprise one or more of: a resource ID, a maximum UE transmit power, a UE transmit beam ID, a transmission configuration indicator (TCI) state, reference signals, or a device group.

6. The method of claim 5, wherein the device group is associated with one or more of: a device type, a device energy level, a device battery capacity, a mobility condition of the device, or the time since elapsed since the last device's successful access attempt.

7. The method of claim 1, wherein the first and the second AIoT messages indicate one or more assistance information associated with the resource being used.

8. The method of claim 1, wherein the determination that the overload occasion occurred is based on at least one of a number of resources used by the devices or a number of devices with successful attempts.

9. The method of claim 1, wherein the first and the second AIoT messages are AIoT paging messages.

10. The method of claim 1, wherein the configuration information, the first assistance information and the second assistance information are received in one or more radio resource control (RRC) messages.

11. A wireless transmit and receive unit (WTRU), the WTRU comprising:
a transceiver; and
one or more processors
wherein the transceiver and the one or more processors are configured to:
receive, from a network, first configuration information comprising first resource information, wherein the first resource information includes an indication of time and frequency resources to be used in an ambient Internet of things (AIoT) access procedure;
receive, from the network, first assistance information comprising first assistance parameters associated with the first resource;
send the first AIoT message using the first resource and the first assistance parameters;
monitor access occasions and determining that an overload occasion occurred;
send, to the network, an overload indication;
receive, from the network, second assistance information comprising second assistance parameters; and
send the second AIoT message using the first resource and the second assistance parameters.

12. The WTRU of claim 11, wherein the first assistance parameters include one or more of: a maximum UE transmit power, a number of frequency occasions, a number of time occasions, or a time occasion type.

13. The WTRU of claim 12, wherein the time occasion type comprises periodic type, aperiodic type or semi-persistent type.

14. The WTRU of claim 11, wherein the first assistance parameters comprise a random access time window including one or more of: a start time, an end time, a periodicity, or a time offset.

15. The WTRU of claim 11, wherein the second assistance parameters comprise one or more of: a resource ID, a maximum UE transmit power, a UE transmit beam ID, a transmission configuration indicator (TCI) state, reference signals, or a device group.

16. The WTRU of claim 15, wherein the device group is associated with one or more of: a device type, a device energy level, a device battery capacity, a mobility condition of the device, or the time since elapsed since the last device's successful access attempt.

17. The WTRU of claim 11, wherein the first and the second AIoT messages indicate one or more assistance information associated with the resource being used.

18. The WTRU of claim 11, wherein the determination that the overload occasion occurred is based on at least one of a number of resources used by the devices or a number of devices with successful attempts.

19. The WTRU of claim 11, wherein the first and the second AIoT messages are AIoT paging messages.

20. The WTRU of claim 11, wherein the configuration information, the first assistance information and the second assistance information are received in one or more radio resource control (RRC) messages.
